(19) United States
(12) Patent Application Publication
(10) Pub. No.: US 2024/0407898 A1
(43) Pub. Date: Dec. 12, 2024

(54) DETERMINATION OF STRUCTURAL CHARACTERISTICS OF AN OBJECT

(71) Applicant: Perimetrics, Inc., Redmond, WA (US)

(72) Inventors: Dennis A Quan, JR., Cary, NC (US); Aboozar Mapar, Lake Forest, CA (US); Jeremy N Rotman, Northridge, CA (US); James C Earthman, Irvine, CA (US); Cherilyn G Sheets, Newport Beach, CA (US)

(21) Appl. No.: 18/812,535

(22) Filed: Aug. 22, 2024

Related U.S. Application Data
(63) Continuation-in-part of application No. PCT/US23/63294, filed on Feb. 24, 2023.
(63) Continuation-in-part of application No. 16/731,020, filed on Dec. 30, 2019, now Pat. No. 12,082,940.
(60) Provisional application No. 63/313,405, filed on Feb. 24, 2022.
(60) Provisional application No. 63/313,407, filed on Feb. 24, 2022.
(60) Provisional application No. 63/313,409, filed on Feb. 24, 2022.
(60) Provisional application No. 62/786,494, filed on Dec. 30, 2018.

(51) Int. Cl. A61C 19/04; A61C 3/00

(52) U.S. Cl. CPC A61C 19/04; A61C 3/00

(57) ABSTRACT

The present invention relates generally to a system and method for measuring the structural characteristics of an object. The object is subjected to an energy application process and provides an objective, quantitative measurement of structural characteristics of an object. The system may include a device, for example, a percussion instrument, capable of being reproducibly placed against the object undergoing such measurement for reproducible positioning. The invention provides for a system and methods for analyzing measured characteristics utilizing machine learning to create a system for predicting pathologies from measurements.

### CROSS-REFERENCE TO RELATED APPLICATIONS

This application is a continuation-in-part of the following applications: Patent Cooperation Treaty international patent application Ser. No. PCT/US2023/063294, which claims the benefit and priority of the following U.S. provisional patent applications: Ser. Nos. 63/313,405, 63/313,407, 63/313,409; and U.S. patent application Ser. No. 16/731,020, which claims the benefit and priority of U.S. provisional patent application Ser. No. 62/786,494. This application claims the benefit and priority of all of the foregoing applications and their priority claims, and the contents of all of the foregoing applications are hereby incorporated by reference in their entireties.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### FIELD OF THE INVENTION

This invention relates generally to evaluation of the structural properties of an object. Specifically, it relates to aided evaluation of the structural characteristics that reflects the integrity of an object using a controlled energy application thereon as well as using machine learning for facilitating the evaluation of the structural characteristics that reflect the integrity of an object using a controlled energy application thereon.

### BACKGROUND OF THE INVENTION

Every object, for example, any structure, either anatomical or non-anatomical including industrial or mechanical, exhibits some kind of structural characteristics that may change with time when the structures are being used in any manner, including those that are merely left standing in place in the environment. For changes that are easily discernable visually or revealed through simple testing, measuring the changes may be easily done. However, when such changes are not easily discernable visually or revealed through simple testing, more complicated testing is needed. Testing to find out such changes is important for the health and longevity of the structure, because such changes may eventually develop into forms of defects that are not repairable over time if left unchecked or untreated. To determine the characteristics of the structure, a number of ways may be used, but a majority of tests are likely destructive or invasive if such changes are internal.

When an object is subjected to an impact force, a stress wave is transmitted through the object. This stress wave causes deformations in the internal structure of the object. As the object deforms it acts, in part, as a shock absorber, dissipating a portion of the mechanical energy associated with the impact. The ability of the object to dissipate mechanical energy, commonly referred to as the “damping capacity” of the object, depends on several factors, including the type and structural integrity of the materials making up the object.

There are instruments that are capable of measuring the damping capacity of an object. An example of such an instrument is described in U.S. Pat. No. 6,120,466 (“the '466 patent”). The instrument disclosed in the '466 patent provides an objective, quantitative measurement of the damping capacity of an object, referred to as the loss coefficient. The energy of an elastic wave attenuates relatively quickly in materials with a relatively high loss coefficient, whereas the energy of an elastic wave attenuates relatively slowly in materials with a relatively low loss coefficient.

### SUMMARY OF THE PRESENT INVENTION

The present invention relates to a system and method for measuring and evaluating structural characteristics of an object, whether anatomical or non-anatomical, in a non-invasive manner and/or using a non-destructive method of measurement. Structural characteristics of an object may be identified based on measurements of the same or other objects previously made using and captured by the system. The system may include a device capable of applying energy to an object, which maybe an anatomical or mechanical object; measuring, for a time interval, a response, such as energy reflected from the object as a result of the energy application, for example, tapping, the object, or a response such as the deceleration information of the energy application tool, for example, the tapping rod, such as energy return; recording or compiling for analysis by a computational system such measurements; creating a response profile, for example, an energy return curve or energy return graph (ERG), a force return graph (FRG), a displacement return graph (FRG) or another physical return value, as a time profile, or frequency profile to evaluate the characteristics of the object undergoing measurement. The response may generally be generated from measurement of force, energy, displacement or other physical return value on a sensing mechanism or element, such as over a period of time.

In general, the system may include a program logic module that is trained on a large dataset of waveforms to arrive at optimized decompositions of the waveforms. In exemplary aspects of the invention, the waveforms may be measured signals, such as ERGs, FRGs, DRGs or other physical return value signals, from a percussion measurement device percussing objects or simulations of such signals, and may generally be grouped together based on at least one common characteristic. The program logic module may then apply algorithms to form an initial guess of a decomposition of a signal (e.g. a waveform) into its component sub-signals, perform an optimization to minimize differences between the initial guess decomposition and the original signal, identify and address potential errors or defects in the decomposition, and perform subsequent rounds of guess decompositions and optimizations to form an optimized decomposition. The optimized decomposition, its properties and the methods used to arrive at the optimized decomposition may then be incorporated into the system by codifying in algorithms, such as in machine learning or deep learning algorithms, such that the system is able to more efficiently and accurately decompose new signals that are encountered, such as those acquired from a percussion measurement device generating signals from physical objects.

In some embodiments, the objects may be real, artificial or simulated oral tissues, such as teeth, oral restorations, appliances, implants or splints, and/or associated tissues or orthopedic implants. In general, a percussion measurement device may apply mechanical energy to the object by percussing and measure force/energy/displacement/etc. that is returned to the percussion measurement device, such as by measuring force, energy, displacement or other physical return value on a sensing mechanism, such as over a period of time. The measurements collected may also be the deceleration information from the energy application tool after the energy application process.

In other embodiments, the objects may be mechanical, industrial structures, or composites which may include, but not limited to polymeric composite structures including honeycombs or layered honeycombs or metallic composite structure; an airplane structure, an automobile, a ship, a bridge, a tunnel, a train, a building, industrial structures including, but not limited to power generation facilities, arch structures, or other similar physical structures.

In general, some sensing mechanisms may be inherently limited to detecting response signals in a single direction, such as, for example, only in the direction of compression of a piezoelectric force sensor (i.e., since piezoelectric elements typically only generate signals in response to compression). This may generally result in at least some loss of signal from waveforms or other energy profiles where the amplitude contains a negative portion relative to some baseline, such as a percussion-initiated energy application to an object, as any response from the object that results in the object vibrating, moving away from the sensing mechanism or where mechanical contact or linkage is lost, the sensing mechanism may not detect a portion of the signal due to lack of compression in the proper direction detected by the sensing mechanism. Thus, the ERG generated by the device may be partially incomplete.

For an object, such as a tooth or a mechanical structure, in a pristine state, or without additional perturbations from the pristine state, for example, an undamaged canine or an incisor with one root, the signal comprising the response profile from the object or the deceleration information of the energy application tool during the time interval, such as an ERG, FRG, DRG, etc., may generally take the form of a Gaussian, with one peak, which may resemble the top half of a sine wave (i.e. sinusoid or sinusoid-like shape). However, for an object, such as a tooth, that is not pristine, with cracks or other defects, the response profile may be different and varied. For example, an object with varying degrees of perturbation, for example, may vary from a Gaussian with one peak, to multiple peaks or other deviations from the Gaussian. In some instances, the varied responses may provide good insight into the types of perturbation which may correlate with types of defects, locations of defects, so on. In other instances, some of the response signals may mask some perturbations, and one might have a need to employ additional techniques of analysis, for example, decomposition of the actual response signal collected into more basic sub-signals, so as to evaluate the types of perturbation in order to gain knowledge or additional information about the true structural characteristics. For a sine wave, there are many known mathematical formulae that may be used to aid in the elucidation. However, as stated above, the Gaussian shape resembles only the top half of a sine wave, which may make it difficult to use such mathematical formulae off the shelf to gain information. Also, fundamentally, the percussive system may only produce Gaussian curves that are sine waves with missing bottoms. In some instances, additional processes may also be needed to aid in finding a simulated missing bottom half.

The present inventors have found that, using artificial intelligence, that the signal can be decomposed into a series of one or more sub-signals. These sub-signals may, in many cases, correspond directly to oscillation and/or resonance frequencies induced in defects during percussion. Furthermore, properties of these sub-signals, such as frequency, amplitude, and exponential decay rate, may narrow down or uniquely identify certain physical and/or clinical phenomena.

In an exemplary aspect of the invention, the system may be adapted to accommodate or analyze the signal generated from percussion measurements on an object where the sensing mechanism results in limitation or loss of at least a portion of the return signal.

In some exemplary embodiments, the system may utilize machine learning methods to process and/or analyze the signal that is inherently missing the negative amplitude portion and attempt to reconstruct or treat the signal as having missing parts of the response rather than as a complete response. In the dental field, the machine learning algorithms and methods may be trained on a large set of collected percussion data (e.g. time-energy profiles) from a diverse range of teeth with varied characteristics, such as those of varied type (e.g. incisors, bicuspids, cuspids, molars, etc.), size, number of tooth roots, varied degree of physical damage (e.g. fractures, cavities, etc.), degree or type of restoration (e.g. crown, fillings, etc.), age, etc. to train the algorithms and methods to be able to decompose newly encountered signals into component sub-signals, such as a collection of sinusoid sub-signal that form the signal or an approximation thereof.

The dataset may also be grouped in other manners, such as by location of percussion on the object (e.g. for teeth on the buccal or mesial side, distal or proximal end, etc.), location of the object relative to other reference points (e.g. mandibular vs. maxillary in the oral cavity), by the amount/frequency/number of percussions, or by any other appropriate type of grouping. In such embodiments, the signal may be analyzed and processed as at least one sinusoid signal with a portion of the signal missing from the signal (e.g. the bottom half below a given threshold of the sinusoid is missing from the signal, forming a Gaussian-like shape within the measured timeframe). This may yield greater elucidation of the data as the overall response (or at least an approximation of to account for the missing portion of the signal) may then be considered rather than approaching the response as the portion that is present in the signal alone (i.e. an assumption that the signal is complete without missing portions).

In another aspect of the invention, a machine learning algorithm or set thereof and methods of the system, which may generally be separate or segregated from the machine learning algorithms discussed in conjunction with signal decomposition or other uses, may be trained on a large set of collected signals that may be annotated with characteristics (which may be determined by an “expert” or other trusted characterizer or through machine learning algorithms) to identify, guess with a degree of probability and/or associate a measured signal with the particular characteristics or to choose the proper manner of further analysis or algorithmic manipulation to produce useful outputs for a user to utilize or interpret, such as for selecting a proper plan of further diagnosis, monitoring, treatment, etc. Such machine learning algorithms may be utilized, for example in analyzing or finding correlations between clinical signals and the annotated dataset, such as in heatmaps of numeric metrics or other manners of comparison or analysis.

In an exemplary aspect of the invention, the signal may be recognized, analyzed and/or processed as a summation or conglomeration of multiple different sub-signals that are generated by the interaction of the energy applied to the tooth and the structural features of the tooth and/or surrounding tissues/structures. Without being bound to any particular theory, the signal may generally represent a multitude of different sub-signals each generated by the separate physical structures or features of or around the tooth and may generally each take the approximate form of a sinusoid, such as, for example and without limitation, a decaying sinusoid (e.g. exponentially decaying sinusoids in response to the dissipation by the material/structure/movement of the object), resulting in a summation or conglomeration of the sinusoids to form the overall shape of the signal (or the portion that is detected, i.e., without the missing or “bottom” portion below a given threshold for detection or measurement). In some embodiments, the signal may be decomposed into a “sparse” or limited number of sinusoids (i.e., a bounded number of sinusoids to give the original signal or an approximation of it) to, without being bound to any particular theory, to recognize that each sinusoid is caused by at least one element of the tooth, its restorations if any, and/or surrounding tissue.

In some embodiments, it may generally be recognized that the predominant Gaussian-like form in the signal from a tooth, especially from a pristine or undamaged tooth, may be largely resulting from the response of the PDL (periodontal ligament) absorbing the kinetic energy from the energy application tool. For undamaged healthy teeth, the percussive energy generated by mastication is attenuated by the PDL at the healthy bone-natural tooth interface. Even in cases where the PDL may be absent or defective, the portion of the signal referred to as the PDL portion will refer to that produced due to the anchoring of the tooth or implant directly or indirectly inside the bone that, roughly, produces a pendulum-like response. In general, the PDL portion of the signal may make up most of the amplitude of the signal, and may generally be interpreted as a carrier wave that can be utilized to isolate and/or separate out the responses from other elements of the tooth or surrounding tissue, such as by subtracting the PDL portion out of the signal.

In some embodiments, the PDL signal may simply be the dominant signal generated and not specifically related to the PDL.

In other embodiments, for example, a percussion measurement device may perform measurements on a mechanical device or other object, such as, for example, dental implants, industrial equipment or devices or the like, the predominant signal may be roughly from, for example, the anchoring of the device to the surroundings to produce a pendulum response.

In some exemplary embodiments, the sinusoid decomposition of the signal using machine learning methods may generally include de-tapering the signal (e.g. to remove signal deformations close to the x-axis of the signal, such as, for example, those due to the energy application tool sticking to the tooth), finding initial guesses for larger and/or more obvious sinusoid components of the signal (e.g. typically the sinusoid generated by the PDL), find initial guesses for the remaining sinusoid components of the signal (e.g., those from cracks, damage, separations between layers, or other features) including guesses for the frequencies (e.g., through Fourier Transform-like operations such as by Fast Fourier Transform (FFT) on the signal after subtracting out the initial PDL sinusoid guess), performing an optimization to minimize differences between the original signal and the resultant sum of the initial guess sinusoids to produce candidate sinusoid decompositions, identifying/fixing decomposition defects or errors (e.g., improbable or negatively indicated decomposition results) to rerun the decomposition steps above as needed to remove them, and picking a best or otherwise desired candidate(s) from the resultant decompositions. The resultant decompositions and associated data/results/visualizations may then be displayed or outputted, such as in human-readable form such that a human practitioner or other user may use or interpret them, such as for clinical diagnosis, monitoring and/or treatment planning. The decomposition generated by the system may also generally include determination or computation of uncertainty measures at the various steps of the decomposition, such as to calculate values for error at the various steps or for particular calculations in the decomposition.

In another exemplary aspect of the present invention, the system may generate or calculate various numerical metrics from the decompositions of signals that show statistically significant difference in the datasets such that these numerical metrics may be utilized in probability distributions or heatmaps to aid in predicting or detecting different physical characteristics or attributes by comparison to the numerical metrics derived from decompositions in the clinical setting. For example, numerical metrics generated from datasets that contain known physical characteristics (e.g., damage types on teeth) may be used for comparisons using the same type of numerical metrics derived from a clinical measurement (e.g., from the clinical signal or physical parameters from the clinical measurement), and the probability or degree of matching may be determined by the system to output the likelihood of a match with that particular physical characteristic.

The comparisons may also be done using machine learning algorithms to aid in increasing efficiency and improving the probability matching with the known datasets. For example, basic machine learning methods such as, for example, kernel density estimation and/or calibration curve-adjusted Bayesian networks may be utilized. More advanced comparison methods may also be generated utilizing deep learning methods after developing and/or training the machine learning system sufficiently.

In some embodiments, the system may detect numerical metrics in a clinical measurement that may be indicative or suggestive for the user to alter some physical parameters of the clinical measurement, such as changing the parameters of the percussion measurement device, in order to generate better or more accurate data. For example, some numerical metrics may be indicative or suggestive of using a different percussion force, frequency or location on the object for percussion in order to elucidate additional information or to increase the quality of the measurement.

In general, when an implant replaces natural tooth due to damage or disease, the ligament is generally lost. However, the system and method of the present invention may also be used to evaluate the structural characteristics of an implant structural using abutments. Some materials used for the abutment, for example, composites, gold, and zirconia, may produce sub-signals that somewhat resemble a PDL response.

Further, the present system and method as described above and below may be useful for measuring the dynamic response when forces are applied to the abutment materials and may also be useful to predict the suitability or compatibility prior to implantation, or to choose suitable materials to protect natural teeth adjacent the implants and to making the better choice of materials to minimize the disparity between the way the implants and natural teeth respond to impact.

In some aspects, the present invention relates to a system for compiling test results from a multitude of objects which may or may not include test results of an object tested over a period of time. In some embodiments, each of the test results may be generated using an instrument having housing with an open end or closed end with an energy application tool capable of applying energy to an object to generate a response, for example, a percussive response that may reveal the structural characteristics of the object without substantially affecting the existing structural characteristics of the object.

For example, the device (i.e. percussion measurement device) may include a housing with an open end and a longitudinal axis including an energy application tool mounted inside the housing for movement, from a resting to an active configuration using a drive mechanism supported inside the housing. The housing may include an object contacting portion at its open end or a sleeve may protrude from the open end of the housing for a distance and may include an object contacting portion at its open end adapted for resting the device on at least a portion of the object, and adapted for activating the drive mechanism, hence the energy application tool to impact the object when the object contacting portion of either the housing or the sleeve is resting on at least a portion of the object and for measuring a response after impact and generating a response versus time curve or graph. The response may be captured by a computer coupled to the device, and the response versus time curve.

The system and method may include a device having an energy application tool, for example a tapping tool, capable of applying energy to an object to generate a response, for example, a percussive response that may reveal the structural characteristics of the object without substantially affecting the existing structural characteristics of the object. The energy application tool may be programmed to impact an object a certain number of times per minute at substantially the same speed for a certain time interval during testing. The system may measure, for a time interval, a percussive response such as energy reflected from the object as a result of the energy application, for example, by tapping or applying energy, or the deceleration information of the energy application tool, namely energy return. The response may be fed to a computer and the information is recorded or compiled for analysis by the system, which may include creating a percussive response profile, for example, an ERG, FRG, DRG, etc. or, frequency-based profiles of such, such as those based on the energy/force reflected from the object during a time interval, and/or evaluating the, for example, percussive response profile, for example, a time-response profile, to determine the structural characteristics of the object, for example, vibration damping capacities; acoustic damping capacities; defects including inherent defects in, for example, the bone or the material that made up the object; cracks, micro-cracks, fractures, microfractures; loss of cement seal; cement failure; bond failure; microleakage; lesions; decay; structural characteristic of the foundation or environment to which the object may be anchored or present in, structural integrity in general or structural stability in general.

The system of the present invention. for example, may include a device for performing a percussion action on an object. The percussion measurement device useful in the present invention may come in different configurations, and the testing results produced from some configurations may generate better models than other configurations. In general, the device includes a percussion instrument, capable of being reproducibly placed directly on the object undergoing such measurement for reproducible measurements.

In some exemplary embodiments of the invention, the device used may include a housing with a hollow interior and an open end through which energy may be applied by an energy application tool, including any tool capable of applying any types of energy to the object including mechanical, sound or electromagnetic energy may be positioned. According to some embodiments, a tool capable of applying mechanical energy to the object, such as a tapping rod or impact rod may be positioned or mounted inside the housing passes through to reach the object undergoing measurement. According to some other embodiments, an electromagnetic energy source of any frequency, such as light energy, for example, may be positioned inside the housing. According to a further example, a sound energy source such as an ultrasonic transducer or any acoustic energy source, may be positioned inside the housing.

The device of the present invention may be, for example, a percussion instrument, which may include a handpiece having a housing having a longitudinal axis, with an open end and an energy application tool, for example, a tapping rod, or impact rod mounted inside the housing for axial movement along the longitudinal axis of the housing, or for oscillatory movement about the longitudinal axis of the housing. In some embodiments, the housing may include an object contacting portion capable of being reproducibly placed in contact with the object undergoing such measurement. In some other embodiments, the housing may include at least a portion, such as a sleeve portion extending from the housing for a distance, capable of being reproducibly placed in contact with the object undergoing such measurement. The energy application tool, such as a tapping rod, may have a length and positioned inside the housing and may be programmed to impact an object a certain number of times per minute at substantially the same speed and the deceleration information of the tool or the response of the object from the impact is recorded or compiled for analysis by the system. In some embodiments, the device and hardware may communicate via a wire connection. In some other embodiments, the device and hardware may communicate via a wireless connection.

The system and method useful for performing measurement on an object and for capturing the measurements may include a device having an energy application tool capable of applying energy to an object to generate a measurement. For example, a percussion measurement device may be useful in the present invention and may come in different configurations and forms, for example, a desktop or a portable device such as a handheld device and the testing results produced from some configurations may generate better models than other configurations.

In some embodiments, and the energy application tool, for example, a tapping rod, has a length with a retracted or resting form or configuration and an extended or active form or configuration, the retracted form being retracted from or substantially coextensive with the open end of the housing if the energy application tool is a tapping rod. The movement of the energy application tool, for example, a tapping rod, may be effected by a drive mechanism mounted inside the housing for driving the tapping rod axially within the housing between the aforementioned retracted position and extended position during operation. In the extended position, the free end of the tapping rod is capable of extending or protruding from the open end of the housing. In some other embodiments, the energy application tool, for example, a tapping tool, may be a form substantially parallel to the longitudinal axis of the housing with a tip portion of the tool being substantially perpendicular to the longitudinal axis housing in a resting form or configuration, and move to the active form or configuration where the energy application tool makes an acute angle with the longitudinal axis of the housing, while the tip of the tool remains substantially perpendicular to the longitudinal axis of the housing, by rocking back and forth about a pivot point on the longitudinal axis. In other words, the energy application tool may oscillate from the substantially parallel position to the longitudinal axis of the housing to a position making an acute angle with the longitudinal axis of the housing at a pivot point. The energy application tool may be held either horizontally or in other positions during measurement, and may have a tip portion that is substantially perpendicular to the major portion of the tool and maintains a constant length either at rest or at impact. The movement of the energy application tool, for example, a tapping rod, may be effected by a drive mechanism mounted inside the housing for driving the tapping rod from a substantially parallel position to the longitudinal axis of the housing to a position making an acute angle with the axis at a pivot point and back again, while the tip oscillates up and down in turn. The movement of the energy application tool, for example, a tapping rod, may be effected by a drive mechanism mounted inside the housing for driving the energy application tool.

The drive mechanism may be, for example, an electromagnetic mechanism, and may include an electromagnetic coil. In some embodiments, the drive mechanism may include a permanent magnet secured to the back end of the energy application tool, for example, the tapping rod, and the magnetic coil may lie axially behind this permanent magnet. Together with the back part of the handpiece housing and any electrical supply lines, the magnetic coil forms a structural unit which may be integrally operational and which may be, for example, connected to the remaining device by a suitable releasable connection, for example, a screw-type connection or a plug-type connection. This releasable connection may facilitate cleaning, repairing and others. In some other embodiments, the drive mechanism may be an electromagnetic mechanism and may include an electromagnetic coil and a permanent magnet secured to the back end of the energy application tool, for example, the tapping rod, by an interface, for example, a coil mount. The coil, for example, an electromagnetic coil may lie axially behind the permanent magnet, for example. The electromagnetic coil may also act directly on a metallic or conductive component, such as a ferromagnetic component. Other forms of linear motors may also be employed.

The energy application tool, such as the tapping rod, may be located in the front part of the housing and the mounting mechanism for the tapping rod may include frictionless bearings. These bearings may include one or more axial openings so that the neighboring chambers formed by the housing and the tapping rod are in communication with one another for the exchange of air, dependent on how much information is expected from the test.

For a given energy application tool, for example, for a physical tool such as a tapping rod, the variation of impact force may be effected by, for example, varying voltage, current or both, may vary the coil drive times (varying the length of time the coil is energized or activated), may vary the velocity of the tapping rod traveling towards the object at impact, may vary the coil delay times (varying the time between driving activities), may vary the number of coil energizations (i.e. varying the number of drive pulses applied), polarity of the coil and/or a combination/plurality thereof.

According to some embodiments, the drive mechanism may include a measuring device, for example, a piezoelectric force sensor, located within the handpiece housing for coupling with the energy application tool, such as the tapping rod. The measuring device may be adapted for measuring the deceleration of the tapping rod upon impact with an object during operation, or any vibration caused by the tapping rod on the specimen. The piezoelectric force sensor may detect changes in the properties of the object and may quantify objectively its internal characteristics. Data transmitted by the piezoelectric force sensor may be processed by a system program, to be discussed further below.

According to some other embodiments, the drive mechanism may include a linear variable differential transformer adapted for sensing and/or measuring the displacement of the energy application tool such as the tapping rod, before, during and after the application of energy. The linear variable differential transformer may be a non-contact linear displacement sensor. The sensor may utilize inductive technology and thus capable of sensing any metal target. Also, the noncontact displacement measurement may allow a computer to determine velocity and acceleration just prior to impact so that the effects of gravity may be eliminated from the results. Communication between the drive mechanism and the energy application may be wired or wireless.

Located at the open end of the housing may be an object contacting portion which may or may not include a sleeve. In some embodiments, the open end of the housing may be placed directly in contact with the object during measurement, thus stabilizing the device on the object. In some other embodiments, the sleeve may attach and/or surround at least a length of the free end of the housing and protrudes from the housing at a distance substantially coextensive with the end of the tapping rod in its extended form if the tapping rod moves axially. Thus, the length of the sleeve may be dependent on the length of protrusion of the extended tapping rod desired. The free end of the sleeve may be placed against an object undergoing measurement. The sleeve may be placed directly in contact with the object during measurement, thus stabilizing the device on the object. In other embodiments, additional features may be included to further stabilize the device and may also built in some repeatability of placement of the device on an object, as discussed below.

In other exemplary embodiments of the invention, the device may be as described in the above exemplary embodiments, except that the sleeve may include a tab protruding from at least a portion of its end so that when the open end of the sleeve is in contact with at least a portion of a surface of the object undergoing the measurement, the tab may be resting on a portion of the top of the object. The tab and the sleeve together may assist in the repeatable positioning of the handpiece with respect to the object; thus results are more reproducible than without the tab. In rare situations, the tab may not protrude at all to allow testing at a lower position on the object. The tab may be substantially parallel to the longitudinal axis of the sleeve. In one aspect, the surface of the tab in contact with an object may be contoured, a concave or a convex surface, to be better positioned on the top of the object, for example, a tooth. In another aspect, the surface of the tab in contact with an object may be flat to accommodate the topography of the object, for example, a flat surface. In a further aspect, the surface of the tab in contact with an object have include a groove or groove to accommodate an object with uneven surfaces. In addition, the tab may be adapted for repetitively placed substantially at the same location on the top of the object every time. In some embodiments, the tab may be substantially parallel to the longitudinal axis of the sleeve.

On rare occasions, where the tab may interfere with a stable position on, for example a dental implant transfer abutment, a sleeve portion without a tab may be used for more stable placement lower on the abutment.

In a further exemplary embodiment of the invention, the sleeve may include not only a tab, but also a feature component, for example, a ridge, protrusion or other feature substantially orthogonal to the surface of the tab on the side adapted for facing the surface of an object. For example, for teeth, the ridge or protrusion may nest between adjacent teeth or other orthogonal surface and may thus aid in preventing any substantial lateral or vertical movement of the tab across the surface of the object and/or further aid in repeatability. The tab may be of sufficient length or width, depending on the length or width of the top portion of the object so that the ridge or protrusion may be properly located during operation. Again, the tab and the feature also aid in the reproducible results than without the tab.

In the exemplary embodiments described above, the device may be of any form factor, as noted above, including a handpiece with a longitudinal housing for housing the parts of the device as described above, or a desktop, or any form that is portable. The device, for example, any portable form or a handpiece may be held at any angle to the horizontal during testing.

The stabilization of the instrument effected by a tab or a tab and/or component may minimize any jerky action by the operator that may confound the testing results, for example, any defects inherent in the bone structure or physical or industrial structure may be masked by jerky action of the tester. This type of defect detection is important because the location and extent of the defect may impact dramatically upon the stability of the implant or physical or industrial structures. Generally, when lesions are detected, for example, in an implant, such as a crestal or apical defect, the stability of the implant may be affected if both crestal and apical defect are present. In the past, there is no other way of gathering this type of information other than costly radiation intensive processes. With the present device, this type of information may be gathered, and may be done in an unobtrusive, non-invasive manner without radiation.

In a further exemplary embodiment of the invention, an inclinometer may be present, for example, as part of an electronic control system of any of the above described exemplary embodiments, which may trigger an audible warning when the device is outside of the angular range of operation; for example, for a tapping rod, it may trigger the warning when it is plus/minus approximately 45 degrees, more for example, when it is plus/minus approximately 30 degrees from horizontal to return the device to the more horizontal orientation.

In yet another exemplary embodiment of the invention, any or all of the exemplary embodiments described above may also include a force sensor, not for sensing or measuring the force exerted by the energy application tool on an object during testing, or the response after impact of the energy application tool, but for sensing and/or monitoring that a proper contact force is exerted by the sleeve portion on the object undergoing measurement. As mentioned above, during measurement, for example, the device may contact the object with the end of the housing or the sleeve portion. The contact force may vary depending on the operator. It is desirable that the force be consistently applied in a certain range and that range not be excessive, independent of the operator. A force sensor may be included in the device for sensing this force and may be accompanied by visual signal, voice or digital readout. This sensor may be employed also for assuring that proper alignment against the object during measurement is obtained. The sensor, for example a force sensor, may be in physical proximity and/or contact and/or physically coupled with at least a portion of the device other than the energy application tool; for example, it may be in physical proximity and/or contact and/or physically coupled with the housing and/or sleeve portion, if the open end of the sleeve portion includes an object contacting portion.

In general, the sensor may surround the energy application tool and not be in physical contact with the tool. For example, the sensor maybe positioned such that the energy application tool, even a physical tool, may pass through it to impact the object undergoing measurement. The sensor may include strain gauges, piezoelectric elements, a sensing pad or any other sensor that may be capable of being sandwiched. The sensor, for example the force sensor, may be disposed anywhere inside the housing and be in physical proximity and/or contact and/or physically coupled with at least a portion of the device other than the energy application tool; for example, it may be in physical proximity and/or contact and/or physically coupled with the housing and/or sleeve portion, if the open end of the sleeve portion includes an object contacting portion, as noted above. In some embodiments of the invention, the sensor may include at least one strain gauge for sensing. The strain gauges may be attached or mounted to a cantilever between the device housing and the sleeve portion so that when the object contacting portion of the sleeve portion is pressed on the object it also deforms the cantilever which is measured by the strain gauge, thus providing a force measurement. In some embodiments, multiple strain gauges mounted to a single or to separate cantilevers may be utilized. The cantilever(s) may also, for example, be present on a separate component from the rest of the housing or sleeve portion, such as, for example, on a mounting device. In some other embodiments of the invention, the sensor may include a sensing pad which may be positioned between a rigid surface and a sliding part so that when the pad is pressed or squeezed as the sliding part moves towards the rigid surface, the force is measured. According to some embodiments, the rigid surface may be, for example, a coil interface that holds the electromagnetic coil in the drive mechanism within the device housing of any of the above or below exemplary embodiments. The sliding part may be a force transfer sleeve-like component or member disposed inside the housing and coupled to the object contacting portion of the sleeve portion and adapted to slide inside the housing when a force is exerted by the object contacting portion of the sleeve portion on an object. In some embodiments, it may be disposed inside the sleeve portion. The sliding distance may be very small, for example, in the order of about (in millimeters or mm) 0.3 mm to about 1 mm, more for example about 0.5 mm. The sensing pad may include a layer structure, which may be generally referred to as a “Shunt Mode FSR” (force sensing resistor) that may change resistance depending on the force applied to the pad, to provide a force measurement. According to some other embodiments, the force transfer sleeve-like component or member may be biased forward by a spring, so that when force is applied by the object contacting portion of the sleeve portion on the object, the force transfer sleeve-like component or member may transfer the force against the spring. According to one aspect, the force sensing may be done by a linear position sensor, which would know, for example, that if the force transfer sleeve-like portion is at position X, a force of Y has to be applied to it (against the reaction force of the spring) to move it to that position. According to another aspect, the force sensing may be performed by an optical sensor, for optically sensing the position of the moving part, when it is pushed against a spring, In yet some other embodiments of the invention, the relative position of the object contacting portion of the sleeve portion on the object may be determined by having one or more strain gauges which may be attached at one end to a moving part, for example, the force sensor sleeve-like component, and the other end to a static element, for example, the housing. In a further embodiment of the invention, the device may include piezoelectric elements for directly measuring the force. In yet a further embodiment of the invention, a hall effect sensor may be used to detect a change in the magnetic field when a magnet (attached to the moving element) is moving relative to the position of the sensor. In yet some other embodiments of the invention, a capacitive linear encoder system, like that found in digital calipers may be used to measure the force.

In addition to monitoring and sensing the contact force exerted on the object by the operator when the object contacting portion of the housing or the sleeve portion contacts the object, the sensors may also be configured to activate the device when the correct amount of force is exerted on the object by the sleeve portion.

Though the sensor is not physically or mechanically coupled to the energy application tool, it may be in electronic communication with the energy application tool and may act as an on/off switch for the device or instrument, as noted above. For example, when a proper force is exerted on the object by the object contacting portion of the housing or sleeve, it may trigger the activation mechanism of the device or instrument to activate the movement of the energy application tool to start a measurement. Thus, no external switches or push buttons are needed to activate the on and off of the system, as noted above. The indication of the proper force may be indicated by visible or audible signals.

The sleeve portion may be mounted onto a force transfer sleeve-like component, or force transfer member, that forms a permanent part of the front of the housing or protrudes from it, and shields the energy application tool, for example, the tapping rod, from damage when no sleeve portion is present, for example, the sleeve portion may form part of a disposable assembly, as discussed below. The force transfer sleeve-like component or member sits around the energy application tool, for example, a tapping rod; and may surround the energy application tool, is held at the front by the housing and mounts onto the front of the electromagnetic coil at the rear. The force transfer sleeve-like component or member may be adapted to slide a small amount, and in doing so, may act on a force sensor, for example, a force sensitive resistor, located between the back surface of the force transfer sleeve-like component or member and the coil mount. The energy application tool, for example the tapping rod may be triggered when the object contacting portion of the sleeve portion is pushed against an object undergoing measurement; for example, a tooth and a force may be detected. When a correct force within a certain range is detected, the instrument is turned on to start the measurement.

As mentioned above and in all the embodiments of the sensor, the sensor may be arranged to form a channel through which the energy application tool, such as a tapping rod, may pass through to impact the object undergoing measurement, i.e. surrounds the tapping rod.

If the device is oriented such that the axis of operation is greater than about 45 degrees, more for example, greater than about 30 degrees from horizontal when a push force is sensed on the object contacting portion of the sleeve portion, it may result in a warning sound being emitted by a speaker located on the device, such as the printed circuit board (PCB) within the device. In such circumstances, the percussion action will not begin until the device is returned to an acceptable angle. In some instances, if the percussion action has started when the above mentioned above-mentioned departure from the range is detected, the device may not actually stop operation, but may simply be sounding an alarm, so that corrections may be made.

In still a further exemplary embodiment of the invention, any of the above described exemplary embodiments, the system and method may also include a device capable of operating by holding the device at varying angles from the horizontal and modulating the energy application process to mimic a substantially horizontal position during measurement and may provide a system that may apply the optimal amount of energy to an object in all situations. In some embodiments, the device may exert a substantially the same impact force on the object in various angles from the perpendicular direction of the object surface, as if the device is operating so that the direction of propagation is perpendicular to the surface of the object. Thus, whether the device is operating at about plus/minus 45 degrees, more for example, about plus/minus 30 degrees from the perpendicular direction with respect to the object surface, the device may still generate about the same amount of an equivalent impact force, for example, about 20-30 newtons, for optimal results. The system may include visual indicators, such as LEDs in instances when the handpiece is held at an angle that does not support reliable measurements. The LEDs in such instances may turn red or any other preset color to indicate such circumstances to alert the user to readjust the angle the handpiece is been held.

The system and method of the present invention may, such as increase flexibility of operation, for example, to adapt for reaching hard to reach objects, both anatomical and non-anatomical, to detect any abnormalities that may be present in an object to generate more reproducible measurements, and also to better be able to detect any abnormalities that may be present in an object. The device may include a housing with a hollow interior and an open end through which an energy application tool, including any tool capable of applying any types of energy to the object, for example, a tool capable of applying mechanical energy to the object, such as a tapping rod, positioned inside the housing passes through to reach the object undergoing measurement, an electromagnetic energy of any frequency, for example, light, a sound wave such as acoustic energy.

For example, the system may include a device for performing a percussion action on an object. The device, having a housing with a hollow interior and an open end through which energy may be applied by an energy application tool, including any tool capable of applying any types of energy to the object including mechanical, sound or electromagnetic energy may be positioned. In some embodiments, a tool capable of applying mechanical energy to the object, such as a tapping rod may be positioned inside the housing passes through to reach the object undergoing measurement. In some other embodiments, an electromagnetic energy source of any frequency, such as light energy, for example, may be positioned inside the housing. In a further example, a sound energy source such as an ultrasonic transducer or any acoustic energy source, may be positioned inside the housing.

The energy application tool may be held either horizontally or in other positions during measurement, and may have a tip portion that is substantially perpendicular to the major portion of the tool and maintains a constant length either at rest or at impact. In this latter embodiment, if the tool is a mechanical tool, such as a tapping rod, it may or may not include a removable tool tip that is substantially perpendicular to the longitudinal axis of the tool and housing.

The energy application tool, such as the tapping rod, may be programmed to strike an object a certain number of times per minute at substantially the same speed and the deceleration information may be recorded or compiled for analysis by the system, as noted above. The sleeve portion, in addition to aiding in positioning the device, may also aid in attenuating any vibrations caused by the impact so as to not disturb the sensitive measurements, if it is of a material having some damping properties.

For electromagnetic energy, the energy application may be in the form of pulses or energy bursts which may be programmed to impact an object a certain number of times per minute with substantially the same amount of energy each time and the effect on the object may be recorded or compiled for analysis by the system. In some instances, the repeated impact may provide an average measurement that may be better representative of the actual underlying property. The sleeve portion, in addition to aiding in positioning the device, may also aid in attenuating any vibrations caused by the impact so as to not disturb the sensitive measurements, if it is of a material having some damping properties.

Upon activation of, for example, a mechanical energy application tool, for example, the pressing of a finger switch on the device, or activated when a certain amount of force is exerted by the object contacting portion of the housing or the sleeve, as described above, a magnetic coil within the device propels the energy application tool, such as a tapping rod to extend at a speed towards an object undergoing measurement and strike or impact the object or specimen, for example, multiple times per measuring cycle with an impact force. In some instances, as in the case when it is desirable to generate a large number of signals in a controlled laboratory setting, when the handpiece maybe positioned in a mount, the handpiece may be set up to be activated without waiting for the right amount of contact force exerted by the object contacting portion of the housing or the sleeve. The impact force on the object may create stress waves that traveled through the energy application tool, such as the tapping rod and the deceleration of the tool such as the tapping rod upon impact with the object may be measured by a measuring or sensing device or mechanism located in the device and transmitted to the rest of the system for analysis. The system may measure, for a time interval, a percussion response such as energy reflected from the object as a result of the energy application, for example, by tapping or applying energy, which may include creating a percussion response profile, for example, a signal, or frequency-response profile, based on the response from the object during the time interval, and/or evaluating the percussion response profile, for example, the signal to determine the damping capacity of the object or other characteristics. The measuring device or sensing mechanism may detect characteristics of the effects from the impact of the energy application tool with the object. In general, the measuring device or sensing mechanism may be physically coupled to, functionally coupled to or otherwise in contact with the energy application tool such that it may detect characteristics of the impact. The coupling may be wired or wireless.

After impact with the object, the energy application tool, for example the tapping rod, decelerates, as noted above. The deceleration of the energy application tool, for example a tapping rod, may be measured by a measuring device or sensing mechanism, for example, an accelerometer inside the device. For example, the accelerometer within the device coupled with the energy application tool may be adapted for measuring the deceleration of the energy application tool upon impact with an object during operation, the percussion response from the object, measuring any vibration caused by the impact or measuring signals corresponding to the resulting stress waves. The measuring device or sensing mechanism may detect changes in the properties of the object and may quantify objectively its internal characteristics. Data transmitted by the measuring device or sensing mechanism may be processed by a system program, as noted before or below.

The above described measuring mechanism may also be applicable to other than mechanical energy application tools described above, with similar sensor set up, for example, when such energy application tools perform a percussion action.

In some embodiments, the inclinometer may include an accelerometer, such as a 3-axis device which measures gravity on all three axes, the X, Y and Z axes. In some embodiments of the invention, the device, such as a handpiece, may include software for measuring the value of the Y-axis (i.e. vertical) gravitational force (G-force). For example, if the G-force for the Y-axis is greater than about the plus/minus, say, 15 degrees threshold, the handpiece may make an audible noise, such as beeps, or a light signal such as a flashing light, or a light of a certain color. If the G-force for the Y-axis is greater than the 30-degree threshold, the handpiece may beep faster, or if a light signal such as a flashing light, it may be a faster flashing light. The accelerometer may be sampled every, say, 100 ms. Five consecutive valid readings may be needed (500 ms) to trigger a threshold and thus the beep or the flash, etc. The thresholds for both the 15 and 30-degree thresholds may be determined empirically.

For example, for a device without the features of the present invention, during operation, if the equivalent impact force is about 26 newtons at plus 15 degrees from the horizontal, the equivalent impact force may be about 32 newtons at a horizontal position, and at minus 15 degrees from the horizontal, the impact force may be about 35 newtons. With the present invention, all impact forces at all the above-mentioned angles may be at about 25 newtons or whatever optimal impact force is programmed.

As noted above, the system may be turned on and off with or without an external switch, or remote control. In some embodiments, the energy application process of the handpiece may be triggered via a mechanical mechanism, such as by a switch mechanism. In one aspect, a finger switch may be located at a convenient location on the handpiece for easy activation by the operator. In another aspect, the switch mechanism may be triggered by applied pressure to the object through the sleeve. In some other embodiments, the energy application process of the handpiece may be triggered via voice control or foot control or a button in the computer software user interface.

Generally, any external switching device such as a flip switch, a rocking switch or a push button switch, may tend to restrict the manner an operator holds the instrument and thus may restrict the positioning of the instrument on the object, if it is handheld, for example, during measurement so as to enable easy access by the operator to the switching device for turning it on and/or off.

In some embodiments, to gain more flexibility in positioning the instrument, voice control or remote control may generally be used, though such voice controls or remote controls may add complexity to the system. In the present invention, the same advantages of flexibility may be gained without such remote controls or added complexities.

In some other embodiments, to gain more flexibility in positioning the instrument, activation of the device may be controlled by a proper contact force between the object and a sleeve portion located at the open end of the housing, as noted above and below. This proper contact force may also add other desirable features to the system, as discussed below. The sleeve portion may be open at its free end, with an object resting, pressing or contacting portion for resting on, pressing or contacting at least a portion of an object during measurement. The contact by the sleeve portion aids to stabilize the device on the object. During measurement, the force exerted by the sleeve portion on an object is controlled by an operator, unlike the impact force of the energy application tool, which may be controlled by the various factors of the system described above, and a proper contact force on the object may be important and may need to be monitored, since, for example, either insufficient or excessive force exerted by an operator may complicate the measurements, and may even produce less accurate results. A sensor disposed inside the housing, not physically or mechanically coupled to the energy application tool may be present to ensure that a proper contact force by the contacting portion of the sleeve portion may be applied by the operator for better reproducibility, even by different operators.

In some embodiments, the instrument may be instantaneously turned on once a proper contact force is exerted by the object contacting portion of the sleeve on the object, as indicated by visible or audible signals. In some other embodiments, there may be a delay prior to turning on the instrument once a proper contact force is exerted by the object contacting portion of the sleeve on the object, as indicated by visible or audible signals. In a further embodiment, once a certain push force between the object contacting portion of the sleeve portion and the object is detected and maintained for a period of time, for example, about 1 second, more for example. about 0.5 seconds, the instrument may be turned on to start measurement. In this embodiment, a green light lights up the tip, and percussion will begin approximately 1 second, more for example, 0.5 seconds after a force in the correct range is maintained.

The proper force exerted by the operator on the object, for example, through the sleeve portion, acts as a switch of the system. When the system is not switched on, it may be desirable to know whether it has malfunction, not sufficient force or too much force is exerted. In some embodiments, the force measurement may be connected to a visual output, such as lights. Lights may be mounted at any convenient location on the device or instrument, for example, one or multiple LEDs may be mounted at the front of the device or instrument. In one aspect, a multiple light system may be included. For example, two LEDs may be used. When the force is in the correct range, the green light may be lit. If too much force is detected, the LEDs may change to red, and the instrument will not work unless the push force is reduced. In some embodiments, if the user is pushing too hard on the object, the light may change first to amber, then to red. If the push force is sufficient to change the light to red, percussion may either not be started, or be interrupted if it has already started. In addition, there may be an amber LED state which warns when the user is approaching too much push force. At that stage, the instrument may still operate when the LEDs are lit amber. In another aspect, no light may indicate too little force, a green light may indicate the right amount of force, while a red light may indicate too much force. In yet another aspect, a one light system may be included. For example, no light may give a signal of too little force and a red light may give a signal of too much force. In a further aspect, a flashing red light may indicate too much force and no light may indicate too little force.

In some other embodiments, the force measurement may be connected to an audible output. In one aspect, the audible output may include a beeping sound to indicate too little force and a multiple beep to indicate too much force. In another aspect, the audible output may include a beeping sound to indicate too little force and a beeping sound with a flashing red light to indicate too much force. In a further aspect, the force measurement may be connected to a voice alert system for alerting too much force or too little force. In yet a further aspect, the force measurement may be connected to a voice alert system to alert too little force and a voice alert and a flashing red light for alerting too much force.

During measurement, as noted above, the system may measure, for a time interval, a percussive response such as energy reflected from the object as a result of the energy application, for example, by tapping or applying energy, or the deceleration information of the energy application tool, namely energy return. The response may be fed to a computer and the information is recorded or compiled for analysis by the system, which may include creating a percussive response profile, and/or evaluating the percussive response profile to aid in determining the structural characteristics of the object, for example, vibration damping capacities; acoustic damping capacities; defects including inherent defects in, for example, the bone or the material that made up the object; cracks, micro-cracks, fractures, microfractures; loss of cement seal; cement failure; bond failure; microleakage; lesions; decay; structural integrity in general or structural stability in general.

Loss coefficient in general is an indication of the overall ability in damping capability in the object or structure being tested. In the percussion process, it is based on the maximum energy return or percussion force squared that are measured with the measuring or sensing mechanism coupled to the energy application tool, for example, the percussion rod, as discussed above and below. The normal fit error (NFE) or damage or instability, is the overall error (difference) between an ideal curve (generated by a defect free object) and the actual test data. These results may be calculated from the ERG, FRG or other physical return value or metric. All response curves are normalized to a maximum of one prior to determining NFE and thus it is not directly related to loss coefficient.

As mentioned above, the system and method of the present invention is non-destructive and non-invasive, and may include a device capable of operating by holding the device at varying angles from the horizontal and modulating the energy application process to mimic a substantially horizontal position during measurement. The system may or may not include disposable parts and/or features for aiding in repositionability. The present system and method for measuring structural characteristics may minimize impact, even minute impact on the object undergoing measurement, without compromising the sensitivity of the measurement or operation of the system. When the energy application tool is a tapping rod, the amount of impact energy may also vary dependent on, for example, the length of the rod, the diameter of the rod, the weight of the rod or the velocity of the rod prior to impact, so on. In some embodiments, the system includes an energy application tool that is light weight and/or capable of moving at a slower velocity such that it minimizes the force of impact on the object during measurement while exhibiting, maintaining or providing equivalent or better sensitivity of measurement. In one aspect, the energy application tool, for example, the tapping rod, may be made of lighter material to minimize the weight of the handpiece and thus may minimize impact on the object undergoing measurement. In some other embodiments, the energy application tool, for example, the tapping rod, may be made shorter and/or of smaller diameter such that the size of the handpiece may also be minimized and thus may minimize impact on the object undergoing measurement. In a further embodiment, the system may include a drive mechanism that may lessen the acceleration of the energy application tool and thus may minimize impact on the object undergoing measurement. For example, the drive mechanism may include a separate drive coil to lessen the acceleration of the energy application tool, whether or not it is light weight, and/or smaller in length or diameter, and minimizes the impact force on the object during operation while maintaining sensitivity of measurement. These embodiments may be combined with one or more of the embodiments described before or below, including the lighter weight handpiece housing. The speed of conducting measurement may also be desirable without increasing the initial velocity of impact so as to minimize impact on the object during measurement. The system may or may not have disposable parts and/or features for aiding in repositionability mentioned above or below.

The system may include a drive mechanism that may vary the travel distance of the energy application tool, while maintaining an initial velocity of impact of the object by the energy application tool. For example, when the energy application tool includes a tapping tool, the distance may vary between a range of about 2 mm to about 4 mm. The decrease of the travel distance of the energy application tool, for example, from about 4 mm to about 2 mm, while maintaining the same initial velocity at impact, or contact, may enable faster measurement without compromising the operation of the system. The system may or may not include the various exemplary embodiments described above or below. For example, the system may or may not have disposable parts and/or features for aiding in repositionability and/or lessening impact with features mentioned before or below.

For any of the exemplary embodiments above, a system and method for measuring structural characteristics using an energy application tool may also include disposable features for aiding in eliminating or minimizing contamination of the object undergoing the measurement through transfer from the system or cross-contamination from previous objects undergoing the measurements, without interfering with the measurement or the capability of the system. The instrument includes a housing having a hollow interior with an open end and an energy application tool, for example, a tapping rod, or impact rod mounted inside the housing for movement inside the housing. The system provides a non-destructive method of measurement with some contact with the object undergoing such measurement without the need for wiping or autoclaving of the energy application tool, and at the same time without disposing of the energy application tool and/or the housing and whatever may be housed inside the housing of the instrument.

The disposable feature may include a covering for covering or enveloping a part of the system that may come into proximity or contact with the object undergoing the measurement without interfering with the sensitivity, reproducibility, if desired, or general operation of the instrument to any substantial degree.

The disposable feature may include any of those described below or as disclosed in U.S. Pat. No. 9,869,606, or WO2011/160102A9, entitled “System and Method For Determining Structural Characteristics Of An Object”, the contents of which is hereby incorporated by reference in its entirety.

The disposable feature may include a sleeve portion extending from and/or enveloping the open end of the housing. In one example, for a mechanical energy application tool, the sleeve portion includes a hollow interior and an open free end with an object resting or contacting portion for resting on, pressing or contacting an object during measurement at its open end. A feature such as a contact feature, which may or may not be movable, having a length and disposed towards the open end of the sleeve portion, and may include a closed end for substantially closing the off the free end of the sleeve portion. substantially closing off fits snuggly inside the sleeve portion, for example, by friction. The contact feature may be, for example, a short tubular section, or a ring and may include a closed end for substantially closing the off the free end of the sleeve portion. The contact feature may be positioned in between the tip of the energy application tool and the surface of the object undergoing measurement. The contact feature described above may include a membrane that may be attached or formed integrally, as described above and below, to form the closed end. The membrane may be thick or thin, as long as they are chosen to have a minimal effect on the operation of the energy application tool. For example, the closed end, whether it is closed by a membrane or other structure, may possess some elasticity or be deformable, and may adjust itself to various surface configurations of an object undergoing measurement, so that close contact with the object may be achieved during impact.

The closed end may include a thin polymeric membrane, which may or may not be of the same material as the rest of the contact feature, or it may be a material having substantially the same properties as the rest of the contact feature. The polymer may include any polymeric material that is capable of being molded, cast or stretched into a thin membrane so that it does not substantially adversely affect the measurement. In some other embodiments, the closed end may include an insert molded metal foil membrane. The metal may be any metallic material that may be drawn, cast or molded into a thin membrane so that it does not substantially adversely affect the measurement. The membrane may also be formed to conform to the shape of the energy application tool, or vice versa, for optimal transfer of force/energy. In some embodiments, the membrane may be constructed from stainless steel foil or sheet, and may, for example, be stamped and/or molded. In other embodiments, the closed end may be integral to the contact feature. For example, the contact feature may be formed from a material which may be shaped into a tubular or ring structure with a closed end of a desired thickness, such as by stamping a metal (e.g. stainless steel, aluminum, copper, or other appropriate metal).

In addition, the sleeve portion, the contact feature and tab and/or the sleeve, the tab and the component, may be made of recyclable, compostable or biodegradable materials which are especially useful in those embodiments that are meant to be disposed of after one use.

The device itself may be tethered to an external power supply or be powered by an electrical source included inside the housing, such as, for example, a battery, a capacitor, a transducer, a solar cell, an external source and/or any other appropriate source.

The system and method may be applicable for testing various objects that are mechanical, as noted before. For a mechanical object, which may include, but not limited to polymeric composite structures including honeycombs or layered honeycombs or metallic composite structure; an airplane structure, an automobile, a ship, a bridge, a tunnel, a train, a building, industrial structures including, but not limited to power generation facilities, arch structures, or other similar physical structures, testing may also be carried out on stationary or a mobile object while moving. Thus, mechanical objects may also be undergoing testing when they are either stationary or moving, which may give particular insight into the object under actual working conditions. For moving objects, such as a train, the testing may be performed over many different spots. This may be performed using one energy application tool, over a plurality of spots on the object, to obtain an average condition of the object in general or be performed on the same spot using many separate tools or devices to obtain an average result on the same spot. For performing measurement on the same spot using many energy application tools, the devices or tools may be positioned, for example, in succession along the path of the moving object over a distance, for example, an array of tapping rod impacting the object, and by controlling the spacing between the tools or devices one may be able to match the speed of the moving object, for example a train, to the spacing of the application of energy on the same spot of the object for obtaining an average value for the spot. In this example, measurements may be performed under actual operating conditions. In some embodiments, the array of devices may be a line array, cither vertical or horizontal arrays, or a curve array. In another aspect, the array may be arranged in a two-dimensional array, planar or curvilinear.

In embodiments where the object is large, measurement at different locations of the object, for example, impacting at a plurality of portions of the object may allow better evaluation of the structural properties that are better representations of the object.

In general, the structural characteristics as defined herein may include vibration damping capacities; acoustic damping capacities; defects including inherent defects in, for example, the bone or the material that made up the object; cracks, micro-cracks, fractures, microfractures; loss of cement seal; cement failure; bond failure; microleakage; lesions; decay; structural integrity in general or structural stability in general. For an anatomical object, such as a tooth structure, a natural tooth, a natural tooth that has a fracture due to wear or trauma, a natural tooth that has become at least partially abscessed, or a natural tooth that has undergone a bone augmentation procedure, a prosthetic dental implant structure, a dental structure, an orthopedic structure or an orthopedic implant, such characteristics may indicate the health of the object, or the health of the underlying foundation to which the object may be anchored or attached. The health of the object and/or the underlying foundation may also be correlated to densities or bone densities or a level of osseointegration; any defects, inherent or otherwise; or cracks, fractures, microfractures, microcracks; loss of cement seal; cement failure; bond failure; microleakage; lesion; or decay. For objects in general, for example, polymeric composite structures including honeycombs or layered honeycombs or metallic composite structure; an airplane structure, an automobile, a ship, a bridge, a building, industrial structures including, but not limited to power generation facilities, arch structures, or other similar physical structures; such measurements may also be correlated to any structural integrity, or structural stability, such as defects or cracks, even hairline fractures or microcracks and so on.

Additionally, changes in the structure of the tooth or any foundation a mechanical structure is attached or anchored to that reduce its ability to dissipate the mechanical energy associated with an impact force, and thus reduce overall structural stability of the, for example, tooth, may be detected by evaluation of the energy return data as compared to an ideal non-damaged sample. In addition, as noted above, the present invention also contributes to the accuracy of the location of detection of defects, cracks, micro-cracks, fractures, microfracture, leakage, lesions, loss of cement seal; microleakage; decay; structural integrity in cement failure; bond failure; general or structural stability in general.

In some exemplary embodiments, the invention comprises:

A method for providing a machine learning-trained structural characteristic analysis system comprising:
providing or generating a dataset comprising a plurality of signals from a plurality of groupings of different objects, said signals being generated from a series of percussion measurements on said different objects and being grouped based on a common characteristic of one of said groupings of different objects;
generating a set of optimized signal collections for each of said signals, each of said set of optimized signal collections being generated by:
   performing a guess decomposition of each of said signals to generate a signal collection for each signal comprising at least one sub-signal;
   performing an optimization operation to minimize differences between said signal collections and each of said signals to generate an optimized signal collection;
   identifying and addressing potential errors or defects in each of said optimized signal collection;
   repeating said guess decomposition and said optimization operation to regenerate an optimized signal collection after said potential errors or defects are addressed;
   selecting at least one desired signal collection from said optimized signal collections for each signal to add to said set of optimized signal collections; and
   incorporating said set of optimized signal collections and associated methods for arriving at said set of optimized signal collections into a machine-learning trained analysis system (MLTA); and
connecting said MLTA to a measurement device, said measurement device being adapted to generate a clinical signal data by percussing a target object and transmitting said clinical signal data to said MLTA to enable said MLTA to process said clinical signal data to produce a clinical optimized signal collection and compare characteristics of said clinical optimized signal collection with characteristics of said set of optimized signal collections and present results of comparison in human-readable form.

In some exemplary embodiments, the invention comprises:
A machine learning-trained structural characteristic analysis system comprising:
a percussion measurement device comprising:
   a housing having an open front end and a longitudinal axis;
   an energy application tool mounted inside said housing, said energy application tool having a resting configuration and an active configuration;
   a drive mechanism supported inside said housing, said drive mechanism being adapted for activating said energy application tool between said resting and active configurations to apply a set amount of energy; and
   a control mechanism connected to provide instructions to said drive mechanism;
   wherein said drive mechanism varies the amount of energy applied to activate said energy application tool between said resting and active configurations based on input from said control mechanism;
a program logic module connected to said control mechanism, said program logic module provided by:
   providing or generating a dataset comprising a plurality of signals from a plurality of groupings of different objects, said signals being generated from a series of percussion measurements on said different objects and being grouped based on a common characteristic of one of said groupings of different objects;
   generating a set of optimized sub-signal collections for each of said signals, each of said set of optimized sub-signal collections being generated by:
   performing a guess decomposition of each of said signals to generate a sub-signal collection for each signal comprising at least one sub-signal;
   performing an optimization operation to minimize differences between said sub-signal collections and each of said signals to generate an optimized sub-signal collection;
   identifying and addressing potential errors or defects in each of said optimized sub-signal collection;
   repeating said guess decomposition and said optimization operation to regenerate an optimized sub-signal collection after said potential errors or defects are addressed;
   selecting at least one desired sub-signal collection from said optimized sub-signal collections for each signal to add to said set of optimized sub-signal collections; and
   incorporating said set of optimized sub-signal collections and associated methods for arriving at said set of optimized sub-signal collections into a machine-learning trained analysis system (MLTA); and
   connecting said MLTA to said percussion measurement device, said percussion measurement device being adapted to generate a clinical signal data by percussing a target object and transmitting said clinical signal data to said MLTA to enable said MLTA to process said clinical signal data to produce a clinical optimized sub-signal collection and a comparison of characteristics of said clinical optimized sub-signal collection with characteristics of said set of optimized sub-signal collections and determines physical parameters associated with said comparison;
a control adjuster connected to said program logic module and said control mechanism, said control adjuster adapted to output changes to said instruction in response to said MLTA outputting a suggested change due to said physical parameters.

In some exemplary embodiments, the invention comprises:
A method for providing a structural characteristic analysis system comprising:
providing a program logic module (PLM) configured to take an input of a signal to generate a signal from a percussion measurement by a percussion measurement device (PMD); connecting said PLM to said PMD;
performing a percussion measurement on a tooth-like object with said PMD to generate said signal with said PLM;
performing a guess for a prominent sub-signal of said signal by fitting of said signal to a basis function;
subtracting said prominent sub-signal from said signal to form a remainder;
performing a guess sinusoid decomposition on said remainder to generate secondary sub-signals that form in summation with said prominent sub-signal an approximation of said signal;
performing an optimization operation to minimize differences between said approximation of said signal and said signals to generate an optimized sub-signal collection;
identifying and addressing potential errors or defects in each of said optimized sub-signal collection;
repeating said guess for said prominent sub-signal, guess sinusoid decomposition and said optimization operation to regenerate said optimized sub-signal collection after said potential errors or defects are addressed;
selecting at least one desired sub-signal collection from said optimized signal collections; and
presenting said desired sub-signal collection in human-readable form.

The present invention together with the above and other advantages may best be understood in conjunction with the following detailed description of the aspects, embodiments and examples of the invention and as illustrated in the drawings. The following description, while indicating various aspects, embodiments and examples of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

FIG. 1 illustrates the connective arrangement of the components of the system of the present invention;

FIGS. 2, 2a, 2b, 2c, 2d, 2e and 2f illustrate embodiments of percussion measurement devices or components thereof of the present invention;

FIGS. 3 and 3a illustrate example profiles of a signal in the present invention;

FIGS. 4 and 4a illustrate an example of the missing portion of a signal;

FIG. 4b illustrates an example of a sub-signal decomposition of a signal;

FIG. 4c illustrates an example of a prominent sub-signal in a signal;

FIG. 4d illustrates a Finite Element Analysis model;

FIG. 4e illustrates the periodontal ligament attached to a tooth-like structure; and

FIGS. 5, 5a and 5b illustrate examples of heatmaps of the present invention.

### DETAILED DESCRIPTION OF THE INVENTION

The detailed description set forth below is intended as a description of some of the exemplified systems, devices and methods provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any systems, methods, devices and materials similar or equivalent to those described herein may be used in the practice or testing of the invention, some of the exemplified systems, methods, devices and materials are now described.

All publications mentioned herein are incorporated herein by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

The present invention relates to a system and method for measuring and evaluating structural characteristics of an object, whether anatomical or non-anatomical, in a non-invasive manner and/or using a non-destructive method of measurement. The damping capacity of an object is an important parameter in a wide variety of applications, including anatomical or non-anatomical objects. For example, in the field of dentistry, when a healthy tooth is subjected to an impact force, the mechanical energy associated with the impact is primarily dissipated by the periodontal ligament. Changes in the structure of the periodontal ligament that reduce its ability to dissipate the mechanical energy associated with an impact force, and thus reduce overall tooth stability, can be detected by measuring the loss coefficient of the tooth.

Objects, whether anatomical or non-anatomical, for example, dental systems, either natural teeth or implants, may also develop defects over time. Some defects require a dental restorative procedure to be performed. Such procedures can be invasive and expensive and incur long recovery times, especially if such defects are not easily discernable until they have developed into more discernable ones that may be severe. There is a significant need for technologies that can quickly validate and pinpoint the kind of issues present and their locations when before the issue becomes severe and/or prior to a disruptive procedure so as to reduce the risk of procedures being performed ineffectively or unnecessarily.

As used herein, the following specialized definitions shall generally apply unless otherwise indicated:

As used herein, “signal” refers to the energy, force, displacement or other physical change value over time returned in a measurement from an object after percussion by a percussion measurement device, as embodied as the electrical response generated by a sensing mechanism such as a piezoelectric sensing element, strain gauge, displacement sensor or the like, the force vs. time data generated by recording such electrical response, or as the graphical representation of the force vs. time data (the Force Return Graph or FRG), the energy vs. time data (the Energy Return Graph or ERG), the displacement vs. time data (the Displacement Return Graph or DRG) or other graphical representations of the applicable data. Unless otherwise indicated, the signal may generally be understood to be in the profile of a waveform representing substantially the total force, energy, displacement or other physical change value vs. time data recorded by the percussion measurement device and received by the system during a measurement which has not been trimmed or manipulated by the system. A “signal” may also refer to a simulated version of the above generated artificially. Different physical change values may also be derived or calculated from the physical value actually being measured.

As used herein, “sub-signal” refers to a component of the signal taking the profile of a waveform, where the summation of all sub-signals results in the original signal or an approximation thereof.

As used herein, “sinusoid” refers to a waveform that adopts the approximate shape of a sine wave, including a sine wave that is decaying in amplitude over time, such as an exponentially decaying or other dampened sinusoid (“decaying sinusoid”).

As used herein, “clinical signal” refers to a signal captured during use of the percussion measurement device in a clinical, industrial or other non-training or non-testing environment by an end user (i.e. “clinician”).

As used herein, “basis function” refers to a function or waveform to fit a signal or sub-signal to, such as, for example, a Gaussian distribution curve, a sinusoid (including decaying or dampened sinusoids as discussed above), exponential functions, sinusoid-like curves, and/or any other appropriate fitting function or waveform.

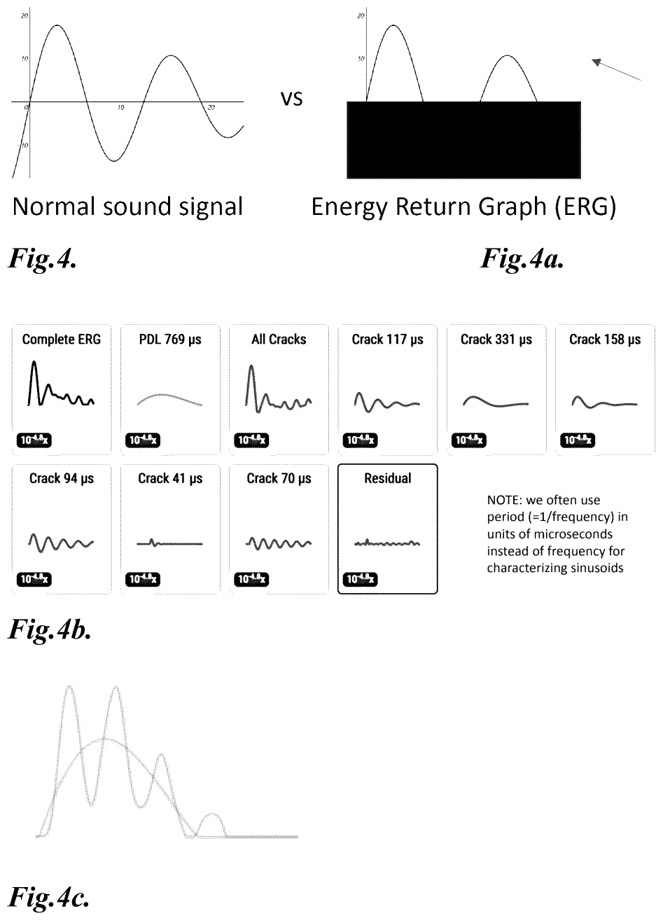

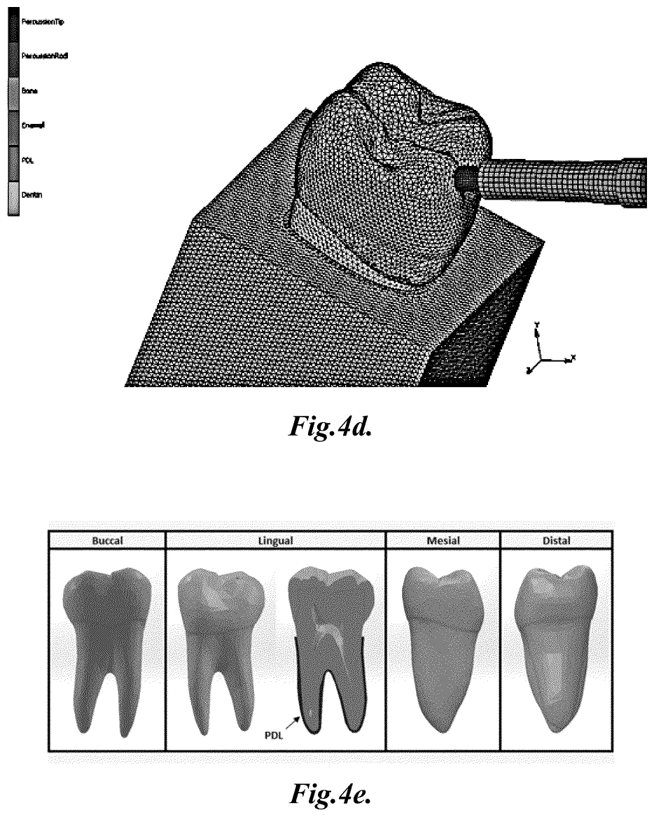

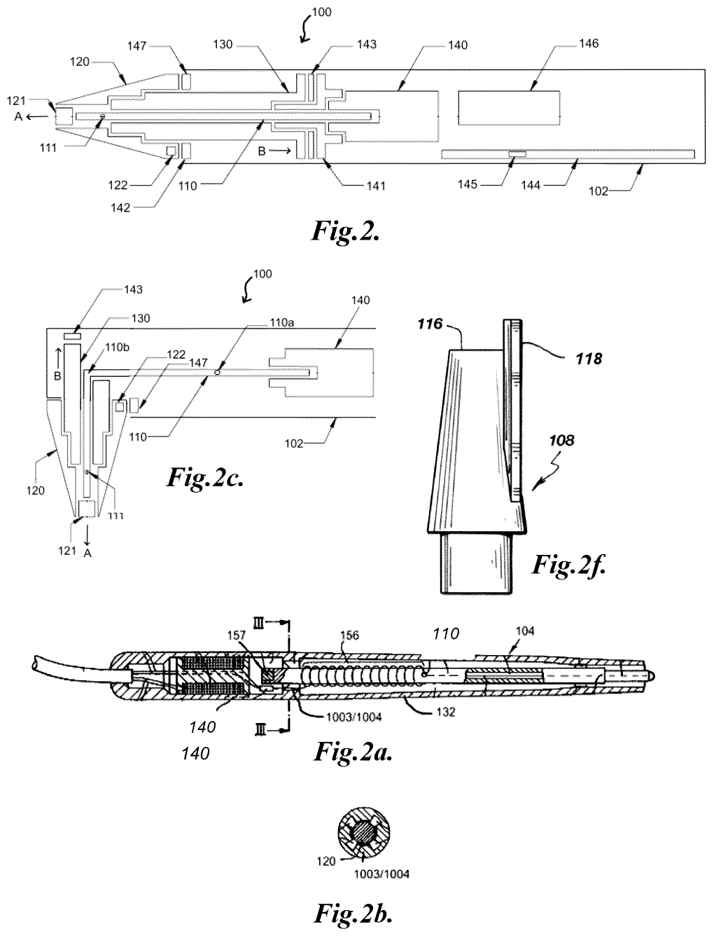

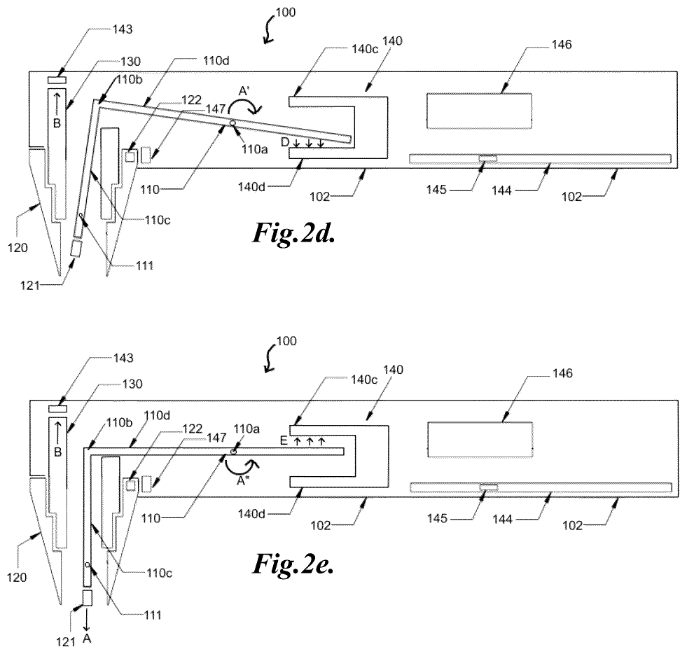

Structural characteristics of an object may be identified based on measurements of the same or other objects previously made using and captured by the system. The system may include a device (i.e. a percussion measurement device) capable of applying energy to an object, which maybe an anatomical or mechanical object; measuring, for a time interval, a response, such as energy reflected from the object as a result of the energy application, for example, tapping, the object, or a response such as the deceleration information of the energy application tool, for example, the tapping rod, such as energy return; recording or compiling for analysis by a computational system such measurements; creating a response profile, for example, a signal, return curve or return graph (e.g. a time profile, or frequency profile) to evaluate the characteristics of the object undergoing measurement (i.e. generating a signal). The signal may generally be generated from measurement of force/energy/displacement/etc. that is returned to the percussion measurement device, such as by measuring force, energy, displacement or other physical return value on a sensing mechanism, such as over a period of time; or the deceleration information from the energy application tool after the energy application process. Several embodiments of a percussion measurement device are described above and below in connection with FIGS. 2, 2a, 2b, 2c, 2d and 2c.

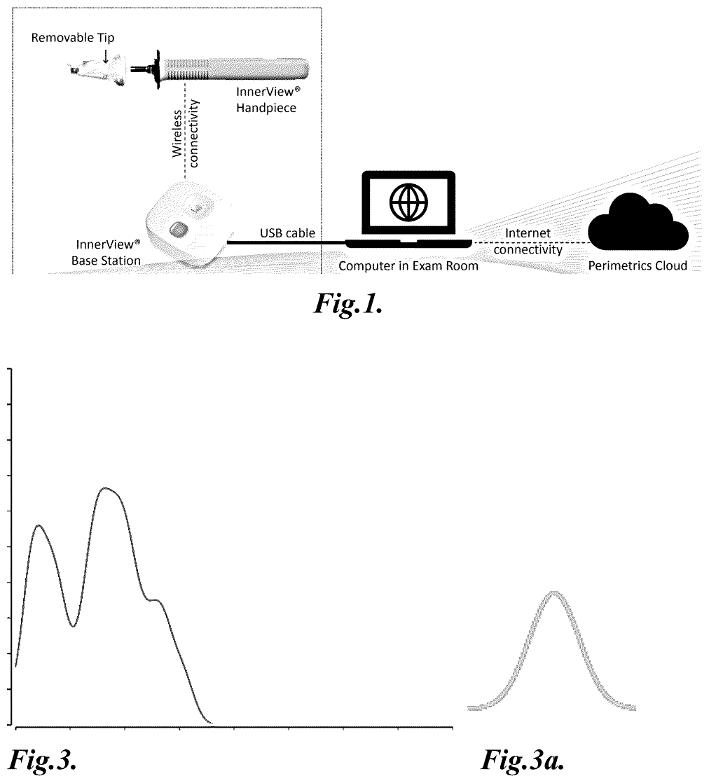

FIG. 1 illustrates an embodiment of the architecture of the system using an endpoint device (i.e. a percussion measurement device as referenced throughout), for example, for a dental measurement. Percussion measurement devices may generally be located in, for example, dentists' offices or other locations where measurements may be taken on object (e.g. teeth, implants, etc.) of patients. A percussion measurement device may generally include or be connected to a computing device such as a PC workstation, a laptop, a tablet, or some other general computing device that may connect to a larger network such as the internet or a private network, such as to a cloud service. At least one device may be attached to the percussion measurement device, either via a wired data transmission technology such as for example USB or FireWire or via a wireless data transmission technology such as Bluetooth. The system may further include a base station, as illustrated for interfacing with the percussion measurement device and the computing device.

The percussion measurement device suitable for use in testing the object may include a housing having a longitudinal axis, with an open end and an energy application tool, for example, a tapping rod, or impact rod mounted inside the housing for axial movement along the longitudinal axis of the housing, as shown in FIG. 2a which shows an embodiment of the percussion measurement device discussed above. In some embodiments, the system may include a handpiece 104, in the form of a percussion instrument. The handpiece 104 may have a cylindrical housing 132 with an open end 132a and a closed end 132b. The open end 132a is tapered as exemplified here, though other configurations are also contemplated. An energy application tool 120, for example, a tapping rod 110, may be mounted inside the housing 132 for axial movement, as noted above. The handpiece also includes a drive mechanism 160, mounted inside the housing 132 for driving the tapping rod 120 axially within the housing 132 between a retracted position and an extended position during operation. The drive mechanism 160 may include an electromagnetic coil 156, to be discussed further below. The tapping rod 110 may have a permanent magnetic ensemble 157 mounted at the end away from the free end. The electromagnetic coil 156 of the drive mechanism 160 may be situated behind the other end of the tapping rod 110, resulting in a relatively small outside diameter for the handpiece 104.

The mounting mechanism for the energy application tool 110, for example, tapping rod 110 may be formed by bearings 1003 and 1004, as shown in FIGS. 2a and 2b, for receiving or supporting the tapping rod 110 in a largely friction-free manner. The magnetic or propulsion coil 156 may be situated in the housing 132 adjacent to the permanent magnet 157 and is axially behind the permanent magnet 157. The magnetic coil 156 and the permanent magnet 157 form a drive for the forward and return motion of the tapping rod 110. The drive coil 156 may be an integral component of the housing 130 and may be connected to a supply hose or line 1000.

The two bearings 1003 and 1004 may be substantially frictionless and may include, as shown in FIGS. 2a and 2b, a plurality of radially inwardly extending ridges separated by axial openings 1400. The axial openings 1400 of the bearing 1003 allow the movement of air between a chamber 1500 which is separated by the bearing 1003 from a chamber 1600, which chambers are formed between an inner wall surface of the housing 132 and the tapping rod 110. Air movement between these chambers 1500 and 1600 may thus compensate for movement of the tapping rod 120.

Referring again to FIG. 2f, a sleeve 108 is positioned towards the end 132a and extending beyond it. The sleeve 108 envelops the end of the housing 132a and is flattened at its end 116 for ease of positioning against a surface of an object during operation. The sleeve aids in the positioning of the handpiece 104 on the object to stabilize the handpiece during operation. The sleeve 108 may also include a tab 118, as shown in FIG. 2f, protruding from a portion of its end 116, so that when the open end 116 of the sleeve 108 is in contact with a surface of the object undergoing the measurement, the tab 118 may be resting on a portion of the top of the object. The tab 118 and the sleeve 108 both assist in the stabilizing and repeatable positioning of the handpiece 104 with respect to the object and the tab 118 may be placed substantially at the same distance from the top of the object every time. As noted above, the object may include an anatomical structure or a physical structure.

FIG. 2 depicts embodiments of other devices (e.g. percussion measurement devices as referenced throughout) that are applicable for the present invention. The system may include a handpiece 100 having a housing 102 which houses the energy application tool and sensing mechanism, as illustrated in the block diagram of FIG. 2 with energy application tool 110 and sensing mechanism 111 which is generally placed to proximal to the end of the energy application tool 110 to receive force or energy from a target. In general, a handpiece may refer to a handheld device, but may also include, without limitation, any other appropriate form for the desired application, such as mounted devices or tool/mechanically/robotically articulated devices. The handpiece 100 may also be referred to, for example, as a device or instrument interchangeably herein. In some embodiments, the energy application tool 110, as illustrated, may be mounted within the housing 102 for axial movement in the direction A toward an object, and such axial movement may be accomplished via a drive mechanism 140. Drive mechanism 140 may generally be a linear motor or actuator, such as an electromagnetic mechanism which may affect the axial position of the energy application tool 110, such as by producing a magnetic field which interacts with at least a portion of the energy application tool 110 to control its position, velocity and/or acceleration through magnetic interaction. For example, an electromagnetic coil disposed at least partially about the energy application 110 may be energized to propel the energy application tool 110 forward toward the object to be measured, as illustrated with the electromagnetic coil 140. The electromagnetic coil may also, for example, be alternatively energized to propel the energy application tool 110 backward to prepare for a subsequent impact. Other elements, such as rebound magnetic elements, may also be included, such as to aid in repositioning of the energy application tool 110 after propelling via the electromagnetic coil. The drive mechanism 140 and/or other portions of the instrument may generally be powered by a power source, as shown with power source 146, which may be a battery, capacitor, solar cell, transducer, connection to an external power source and/or any appropriate combination/plurality thereof. An external connection to a power source, either to power the handpiece 100 or to charge the internal power source, such as the power source 146, may be provided, such as a power interface 147 in FIG. 2, which may include, for example, a power contact for direct conductive charging, or the power interface 147 may utilize wireless charging, such as inductive charging.

In some other embodiments, the energy application tool 110 may be utilized to move substantially in a direction A which may be perpendicular or substantially perpendicular to the longitudinal axis of the housing 102, as illustrated in the block diagram of a handpiece 100 in FIG. 2c. As illustrated, the energy application tool 110 may, for example, be substantially L-shaped to accommodate the interaction with the drive mechanism 140 and protrude in direction A, substantially perpendicular to the axis of the housing 102. As illustrated in an example, the drive mechanism 140 may act on the energy application tool 110 to cause it to rock on a pivot 110a, causing it to move in direction A at its tip. The drive mechanism 140 may utilize, for example, an alternating magnetic element which may act on the energy application tool 110 to cause it to move alternatingly in two directions, such as up and down. In another example, the bend portion of the L-shaped energy application tool 110, such as shown with bend 110b, may include a flexing and/or deformable construction such that a linear force applied by the drive mechanism 140 may push the energy application tool 110 in the direction A at the tip by conveying the forward motion around bend 110b. For example, the bend 110b may include a braided, segmented, spring-like and/or otherwise bendable section that may also convey motion and/or force around a bend. In general, the shape of the L-shaped energy application tool 110 may generally include other angles besides 90 degrees, such as between approximately +/−45 degrees from the rearward portion 110d. In some embodiments, the energy application tool 110 may also include multiple portions which may be separable, such as portions 110c and 110d, such that, for example, the portion 110c may be removed and disposed between uses or patients, such as to aid in preventing cross-contamination. In general, the separable portions may include an interface to couple them for use in a measurement such that they substantially act as a unitary energy application tool 110, as described below.

In some embodiments, the L-shaped energy application tool 110 may rock on a pivot 110a, such as, for example, with an external force applied from a drive mechanism 140, as shown in FIGS. 2d and 2c. For example, the drive mechanism 140 may apply alternating forces to the energy application tool 110 to cause it to rock about the pivot 110a, such as with a force applied D from portion 140d applied to the rearward portion 110d to cause rocking in direction A′ away from a target object, as shown in FIG. 2d, or with a force applied E from portion 140c applied to the rearward portion 110d to cause rocking in a direction A″ toward the target object such that the energy application tool 110 is driven in direction A, as shown in FIG. 2e. The forces D and E may be applied by any appropriate method, such as, for example, by applying a magnetic force on the energy application tool 110, which may contain a magnetic or metallic element which may respond to the application of force from the drive mechanism 140. In general, the shape and arc of the rocking motions A′ and A″ may be designed such that the energy application tool 110 impacts the target object in a direction substantially perpendicular to the target object surface, as shown with the rocking A″ into a substantially vertical orientation of the bent portion 110c around bend 110b in FIG. 2c. To reset the device 100 for a subsequent measurement, the portion 140d may apply a return force D, as shown in FIG. 2d, to cause rocking A′ to return the energy application tool 110 to a withdrawn or resting state. In general, the interior of the device 100 may be adapted to allow for the rocking motions A′ and A″ without interfering with the energy application tool 110.

Other examples of endpoint devices may include, for example and without limitation, those described in U.S. Pat. Nos. 6,120,466, 7,008,385, 6,997,887, 9,358,089 9,869,606, U.S. Pat. No. 10,488,312, PCT/US17/69164, PCT Patent Application Ser. No. PCT/US 20/40386, U.S. patent publication No. 20190331573, PCT/US2018/068083 and/or PCT publication WO2019133946, which are incorporated by reference in their entireties.

In general, the system of the present invention includes a program logic module that may generally be utilized to process a signal received from a percussion measurement device after measuring an object, as discussed above. The program logic module may generally apply algorithms to form at least a portion of an initial guess of a decomposition of a signal into at least one of its component sub-signals. The result may generally be an initial guess decomposition. The program logic module may then perform an optimization to minimize differences between the initial guess decomposition and the original signal, such as through optimization algorithms. This may include, for example, optimizing (i.e. minimizing) the error, absolute error, or square error between the signal and the guess decomposition. For example, gradient descent (also called steepest descent) is a first-order iterative optimization algorithm for finding a local minimum of a differentiable function, which takes repeated steps in the opposite direction of the gradient (or approximate gradient) of the function at the current point, as this is the direction of steepest descent. Gradient descent optimizations may be performed using commercially available or open-source artificial intelligence or high resource computing tools, such as, for example, Google TensorFlow or the like. The optimization algorithm may also be utilized to aid in the guess decomposition where the bottom or negative amplitude of the signal or sub-signal(s) is missing.

After the decomposition is optimized, the program logic module (e.g. either automatically or in conjunction with an expert operator) may then identify and address potential errors or defects in the decomposition, and perform subsequent rounds of guess decompositions and optimizations to form an optimized decomposition. Potential errors or defects may, in some examples, represent improbable or impossible physical situations, results that are apparent or likely mathematical errors, overly complex solutions, and/or other results that indicate an improper decomposition or optimization. Corrections made to potential errors or defects in the decomposition may further be incorporated into the program logic module so that it is better able to identify situations where such potential errors or defects may occur due to characteristics of a signal and be thus able to perform more efficient decompositions without generating solutions with such potential errors or defects.

After addressing potential errors or defects, it may be desirable to repeat the decomposition guess and optimization steps to arrive at a different, modified or new optimized decomposition which does not include or has reduced the addressed potential errors or defects. The process may be reiterated as necessary to eliminate or reduce to a desired level any potential errors or defects in the decomposition.

The optimized decomposition may further be compared to other previous decompositions (e.g. as a whole, by numerical metrics, by common characteristics, by physical parameters of measurement, etc.) to aid a clinician in making determinations or to elucidate information about the structural characteristics of the object.

In some embodiments, the objects may be real, artificial or simulated oral tissues, such as teeth, oral restorations, appliances, implants or splints, and/or associated tissues or orthopedic implants. In general, a percussion measurement device may apply mechanical energy to the object by percussing and measure energy that is returned to the device, such as by measuring force/energy/displacement/etc. that is returned to the percussion measurement device, such as by measuring force, energy, displacement or other physical return value on a sensing mechanism, such as over a period of time.

In other embodiments, the objects may be mechanical, industrial structures, or composites which may include, but not limited to polymeric composite structures including honeycombs or layered honeycombs or metallic composite structure; an airplane structure, an automobile, a ship, a bridge, a tunnel, a train, a building, industrial structures including, but not limited to power generation facilities, arch structures, or other similar physical structures.

In general, as mentioned above, the system of the present invention may include a program logic module that incorporates machine learning algorithm(s) that is trained on a large dataset of signals to arrive at optimized decompositions of sub-signals or a portion thereof. The training of the program logic module may generally occur in a controlled or preproduction environment, such as, for example, in a laboratory, manufacturing or development environment, prior to the use of the system by an end user, such as, for example, a dental practitioner or other clinical/industrial clinician in a non-training or non-testing setting. Of course, signals collected from an actual operational setting (i.e. clinical signals) may be included into or to augment the preexisting dataset, as discussed below, to continue to improve the system through additional training on the augmented dataset, making it a living system. The dataset may generally be based on objects of a single type or a related group of types such that the training may result in an applicable program logic module for a particular field or application, such as in the dental area. In some embodiments, the objects may be real, artificial or simulated oral tissues, such as teeth, oral restorations, appliances, implants or splints, and/or associated tissues or orthopedic implants. In general, a percussion measurement device may apply mechanical energy to the object (if not simulated on a computer) by percussing and measure energy that is returned to the device after impact with an object or the deceleration of the impactor, such as by measuring force/energy/displacement/etc. that is returned to the percussion measurement device, such as by measuring force, energy, displacement or other physical return value on a sensing mechanism, such as over a period of time, to form a signal. For objects simulated on a computer, an energy return may be simulated, such as through Finite Element Analysis (FEA), such as illustrated with the FEA model shown in FIG. 4d, or a constructed signal or sub-signal(s) may be created on a computer or by manipulating/altering preexisting signal or sub-signal(s).

The present invention may also include a simulation model component, which may be utilized in training of the program logic module. FIG. 9 shows an example of an FEA model used as a physical simulation model. This analysis method may involve the use of numerical models to simulate actual testing using the device described herein. In general, modeling and simulation may be desirable for training the system and its predictive capabilities with simulated models that may embody test objects that have not been tested, are not readily available for actual physical testing, etc.

In an example of the modeling, a physiologically accurate 3D model of a mandibular second molar was created using a solid modeling computer-aided design program using 3D x-ray computer tomography tooth data, but the same process may be applicable to other teeth as well as other solid objects. The models include both enamel and dentin together with a pulp chamber, the periodontal ligament (PDL) and surrounding bone, examples of which are shown in FIG. 4d.

The solid models were then exported to a computer-aided engineering program for meshing the solids. A non-linear finite element solver may be appropriate for modeling nonlinear material behaviors such as those reported for the PDL as well as transient environmental conditions including percussion were used. It was necessary to include a percussion rod in the present simulation models to fully analyze a percussion event using comparisons with experimental data. The elastic modulus of the percussion rod, its mass and an initial velocity were inputted into the program. The resultant percussion force was measured by a piezoelectric sensor in the rod.

The FEA models may include a large number of elements, for example, about 500,000 to about 1,000,000 elements each. A second-order isoparametric three-dimensional 4-node tetrahedron for the PDL, an 8-node, isoparametric, arbitrary hexahedral for the percussion probe, and a linear isoparametric three-dimensional tetrahedron for the rest of the model may be used. Boundary conditions may be defined to minimize or prevent free body motion so that the elements on the outer surfaces of the object, for example, the bone may be constrained. The models were run with a time increment of for example, 4 μs.

A direct integration method may be used to obtain the solution to the equations of motion for the models. Additionally, viscous damping may be included in the analysis using classical Rayleigh Damping (RD) which is convenient for an incremental approach to a numerical solution. The damping matrix D is defined as a linear combination of the mass and stiffness matrices of the system and damping coefficients are specified on an element-by-element basis. Rayleigh damping uses coefficients on the element matrices and is represented by the equation D=Σᵢ₌₁ⁿ{αᵢMᵢ+(βᵢ+γᵢΔt/π)Kᵢ}, where D is the global damping matrix, Mᵢ is the mass matrix multiplier for the i^{th} element, Kᵢ is the stiffness matrix multiplier for the i^{th} element, αᵢ is the mass damping coefficient on the i^{th} element, βᵢ is the usual stiffness damping coefficient on the i^{th} element, γᵢ is the numerical damping coefficient on the i^{th} element, and Δt is the time increment. The same damping coefficients may be used throughout the PDL in a given model. The mechanical properties of, for example, the hard dental tissues (i.e. other than the PDL) are assumed to have linear-elastic and isotropic behavior following σᵢⱼ=Cᵢⱼₖₗεₖₗ, where the nonzero components of Cᵢⱼₖₗ are a function of clastic modulus E and Poisson's ratio.

For example and without limitation, a particular dataset may include data derived from measurements on multiple types of teeth, dental implants/appliances, and/or oral tissues (which may also include simulations of such objects or simulations of the data derived therefrom) for the dental field, and preferably with a large diversity of subjects or conditions such that a trained program logic module may be exposed to many possibilities for its optimized decompositions. The dataset may also be updated or augmented through continued use of the system in clinical/industrial settings by end users (i.e. clinicians) such that the program logic module may be trained over time with the augmented dataset as it is used to improve its performance. The improved program logic module may then be propagated for the various clinicians to utilize via updating (e.g. via updates to the cloud stored/operated portions of the system).

In exemplary aspects of the invention, the signals may be measured from a percussion measurement device percussing objects or simulations of such signals, and may generally be grouped together based on at least one common characteristic within the dataset. Examples of such characteristics may include object type, object size, location in a given space or environment, physical condition (e.g. amount/type/location of damage, physical restoration, etc.), position of measurement with a percussion measurement device, object age, treatments or procedures performed on an object, and/or any other applicable physical conditions or simulations thereof. The groupings, without limitation, may also need not be exclusive and multiple, different, overlapping, ad-hoc and/or complex groupings may be utilized.

In exemplary embodiments of the invention, the program logic module may generally apply algorithms, such as the machine learning trained algorithms as described above, to form at least a portion of an initial guess of a decomposition of a signal into at least one of its component sub-signals. Further algorithms of the program logic module, such as machine learning trained algorithms, FFT or Fourier-like operations, gradient descent or similar operations, may also be utilized in conjunction to form the remainder of the initial guess decomposition, as applicable. The result may generally be an initial guess decomposition, as illustrated in FIG. 4b with the complete signal decomposing into eight component sub-signals and a residual sub-signal (e.g. which may represent noise, miniscule or unimportant portions of the signal). The program logic module may then perform an optimization, as discussed in general above, to minimize differences between the initial guess decomposition and the original signal, such as through optimization algorithms, such as gradient descent or similar algorithms (e.g. as implemented with commercially available or open-source artificial intelligence or high resource computing tools, such as, for example, Google TensorFlow or the like). The optimization algorithm may also be utilized to aid in the guess decomposition where the bottom or negative amplitude of the signal or sub-signal(s) is missing.

As generally discussed above, after the decomposition is optimized, the program logic module (e.g. either automatically or in conjunction with an expert operator) may then identify and address potential errors or defects in the decomposition, and perform subsequent rounds of guess decompositions and optimizations to form an optimized decomposition. Potential errors or defects may, in some examples, represent improbable or impossible physical situations, results that are apparent or likely mathematical errors, overly complex solutions, and/or other results that indicate an improper decomposition or optimization. Corrections made to potential errors or defects in the decomposition may further be incorporated into the program logic module so that it is better able to identify situations where such potential errors or defects may occur due to characteristics of a signal and be thus able to perform more efficient decompositions without generating solutions with such potential errors or defects.

After addressing potential errors or defects, it may be desirable to repeat the decomposition guess (e.g. with the machine learning trained algorithms) and optimization steps to arrive at a different, modified or new optimized decomposition which does not include or has reduced the addressed potential errors or defects. The process may be reiterated as necessary to eliminate or reduce to a desired level any potential errors or defects in the decomposition.

The optimized decomposition, its properties and the methods used to arrive at the optimized decomposition may then be incorporated into the system by codifying in algorithms, such as in machine learning or deep learning algorithms, such that the system is able to more efficiently and accurately decompose new signals that are encountered, such as those acquired from a percussion measurement device generating signals from physical objects. The system may also be able to apply the codified algorithms to new simulated datasets, such as those that simulate hypothetical or novel physical characteristics/scenarios.

In some embodiments, the system of the present invention not only can measure and analyze structural characteristics of the object undergoing measurement, but it may also be trained to detect if the correct energy application parameters are used in a clinical setting. For example, with machine learning, the system may notice that the detected response indicates that, for example, for a physical tool such as a tapping rod, too much force is being applied, the duration of each application is too short or too long, the tapping may not be applied at the right location, so on or a combination of the above, and may automatically adjust the device settings to compensate or to prompt the clinician to tap the object at a different location, so as to produce a more optimal response. The system may also recognize these situations as a result of high levels of uncertainty or lack of signal detected during the decomposition process.

In general and without limitation or being bound by any particular theory, energy or force returned to a percussion measurement device may form a signal of only a positive amplitude relative to a baseline (e.g. the x-axis of the signal) and may be missing portions of the signal that are of negative amplitude relative to the baseline. In general, some sensing mechanisms may be inherently limited to detecting response signals in a single direction, such as, for example, only in the direction of compression of a piezoelectric force sensor (i.e., since piezoelectric elements typically only generate signals in response to compression). This may generally result in at least some loss of signal from signals or other energy profiles where the amplitude contains a negative portion relative to some baseline, such as a percussion-initiated energy application to an object, as any response from the object that results in the object vibrating, moving away from the sensing mechanism or where mechanical contact or linkage is lost, the sensing mechanism may not detect a portion of the signal due to lack of compression in the proper direction detected by the sensing mechanism. Thus, the signal generated by the percussion measurement device may be partially incomplete. Also, such sensing mechanisms are generally one-dimensional and are unable to inherently filter or separate out separate sub-signals which may be present in the overall signal received, as they may generally be superimposed over each other. While methods exist to break down such a signal into its component sub-signals, the “missing” portion(s) of the signal may present challenges as standard decomposition methods do not accommodate signals with missing portions. Also, in some percussion measurements, the length of time that the signal is measurable presents additional challenges as it may be too short to capture enough periods (or partial periods) of any signal or its component sub-signals for accurate decomposition.

In an exemplary aspect of the invention, the system may be adapted to accommodate or analyze the signal generated from percussion measurements on an object where the sensing mechanism results in limitation or loss of at least a portion of the return signal. In general, some sensing mechanisms may be inherently limited to detecting response signals in a single direction, such as, for example, only in the direction of compression, such as in the arrangement illustrated for sensing mechanism 111 (e.g. a piezoelectric force sensor) in FIGS. 2, 2a, 2c, 2d and 2e. This may generally result in at least some loss of signal, as discussed above, resulting in a signal generated by the percussion measurement device that may be partially incomplete.

In general and without limitation or being bound by any particular theory, in the dental field, recognition that the PDL generally forms the majority of the dampening from a percussion and that an energy/force return as measured in a signal should present as a sinusoid (e.g. like a soundwave) and yet generally forms only a single peak of approximate Gaussian form, it may be deduced that the PDL response may present in the signal as the first half period of a sinusoid, with the “negative” amplitude. Thus, the PDL sub-signal may generally be deduced as the prominent sub-signal component of the signal and then removed, treating it as like a carrier wave for the remaining sub-signals and enabling their decomposition with generally more standard decomposition methods such as Fast Fourier Transform or similar Fourier-like operations. This may be especially useful as the remaining sub-signals, if present, may generally be sinusoids (e.g. decaying sinusoids) with shorter periods and/or amplitudes which may be captured in the measurement, but obscured or erroneously characterized as other Gaussian forms by the presence of the larger single half period PDL sub-signal. In some situations, it may be recognized that the PDL sub-signal (if present) does not form the prominent sub-signal (e.g. where the PDL is damaged, weakened, not present, etc.) and it may be determined or assumed that another physical characteristic (e.g. a crack or other damage in a tooth or tooth-like structure) may form the prominent sub-signal rather than the PDL.

In some exemplary embodiments, the system may utilize machine learning methods to process and/or analyze the signal that is inherently missing the negative amplitude portion and attempt to reconstruct or treat the signal as missing parts or portions, rather than as a complete response from the measurement. In the dental field, the machine learning algorithms and methods may be trained on a large set of collected percussion data (e.g. ERGs) from a diverse range of teeth with varied characteristics, such as those of varied type (e.g. incisors, bicuspids, cuspids, molars, etc.), size, number of tooth roots, varied degree of physical damage (e.g. fractures, cavities, etc.), degree or type of restoration (e.g. crown, fillings, etc.), age, etc. to train the algorithms and methods to be able to decompose newly encountered signals into component sub-signals, such as a collection of sinusoid sub-signals that form the signal or an approximation thereof.

FIG. 3 illustrates an example of a signal (shown as an ERG or FRG) generated by percussing an object (e.g. a tooth) with a device such as in FIGS. 2, 2a, 2c, 2d and 2e and registering the force returned to a piezoelectric force sensor (e.g. sensing mechanism 111, as below). As shown, the signal does not register any signal above a given threshold (i.e. the X-axis) due to the loss of a portion of the original signal created by the object being percussed. In general, the signal returning from a percussed object may generally form more of a sinusoidal shape (e.g. resembling a soundwave as shown in FIG. 4), which may be rectified or “cut off” by the sensing mechanism (e.g. the piezoelectric force sensor) to generate only the portion of the signal above the threshold (e.g. shown as the cut off signal in FIG. 4a).

The dataset, such as utilized in training the machine learning algorithms or in comparing to clinical signals as discussed above and below, may also be grouped in other manners, such as by location of percussion on the object (e.g. for teeth on the buccal or mesial side, distal or proximal end, etc.), location of the object relative to other reference points (e.g. mandibular vs. maxillary in the oral cavity), by the amount/frequency/number of percussions, or by any other appropriate type of grouping. In such embodiments, the signal may be analyzed and processed as at least one signal with a portion of it missing from the measurement (e.g. the bottom half below a given threshold of the sinusoid is missing from the signal, such as the second half period of a sinusoid which may cross below the threshold, forming a Gaussian-like shape for the first half period, as shown in the signal of FIG. 3a). This may yield greater elucidation of the data as the overall response (or at least an approximation of to account for the missing portion of the signal) may then be considered rather than approaching the signal as the portion that is present in the signal alone (i.e. an assumption that the signal is complete without missing portions of the signal). Further, some data analysis operations may not be able to interpret data properly with the portion of the signal missing (e.g. standard Fast Fourier Transform or other similar Fourier-like operations).

In an exemplary aspect of the invention, the signal may be recognized, analyzed and/or processed as a summation or conglomeration of multiple different sub-signals that are generated by the interaction of the energy applied to the tooth and the structural features of the tooth and/or surrounding tissues/structures. Without being bound to any particular theory, the signal may generally represent a multitude of different sub-signals each generated by the separate physical structures or features of or around the tooth and may generally each take the approximate form of a sinusoid, as illustrated with the sub-signals in FIG. 4b, such as, for example and without limitation, a decaying sinusoid (e.g. exponentially decaying sinusoids in response to the dissipation by the material/structure/movement of the object), as illustrated with the decaying sinusoidal-like forms of FIGS. 4 and 4b, resulting in a summation or conglomeration of the sinusoids to form the overall shape of the signal (or the portion that is detected, i.e., without the missing or “bottom” portion below a given threshold for detection or measurement, as illustrated by FIGS. 3, 4a and 4b (complete signal)). In some embodiments, the signal may be decomposed into a “sparse” or limited number of sinusoids (i.e., a bounded number of sinusoids to give the original signal or an approximation of it) to, without being bound to any particular theory, to recognize that each sinusoid is caused by at least one element of the tooth, its restorations if any, and/or surrounding tissue. An example of a sparse decomposition is illustrated in FIG. 4b with the portion not fully decomposed shown with the illustrated residual.

In some embodiments, it may generally be recognized that the predominant Gaussian form in the signal from a tooth, especially from a pristine or undamaged tooth, is largely resulting from the response of the PDL (periodontal ligament), shown in FIG. 4e, absorbing the kinetic energy from the energy application tool, which may generally appear similar to the single Gaussian-like form in FIG. 3a. For undamaged healthy teeth, the percussive energy generated by mastication is attenuated by the PDL at the healthy bone-natural tooth interface. Even in cases where the PDL may be absent or defective, the portion of the signal referred to as the PDL portion will refer to that produced due to the anchoring of the tooth or implant directly or indirectly inside the bone that, roughly, produces a pendulum-like response. In general, the PDL portion of the signal may make up most of the amplitude of the signal, as illustrated with the single peak signal of the PDL portion in FIG. 4c, and may generally be interpreted as a carrier wave that can be utilized to isolate and/or separate out the responses from other elements of the tooth or surrounding tissue, such as by subtracting the PDL portion out of the signal.

In some exemplary embodiments, the sinusoid decomposition of the signal using machine learning methods may generally include the steps discussed above in regard to a more general signal and its sub-signals, with some particularities for sinusoids to address dental objects such as teeth and implants. For example, the steps may generally include a de-tapering of the signal (e.g. to remove signal deformations close to the x-axis of the signal, such as, for example, those due to the energy application tool sticking to the tooth), finding initial guesses for larger and/or more obvious sinusoid components of the signal (e.g. typically the sinusoid generated by the PDL or other prominent sub-signal), find initial guesses for the remaining sinusoid components of the signal (e.g., those from cracks, damage, separations between layers, or other features) including guesses for the frequencies (e.g., through Fourier Transform-like operations such as by Fast Fourier Transform (FFT) on the signal after subtracting out the initial PDL sinusoid guess, through machine learning or artificial intelligence methods, gradient descent-based methods, etc.), performing an optimization to minimize differences between the original signal of the signal and the resultant sum of the initial guess sinusoids to produce candidate sinusoid decompositions, identifying/fixing decomposition defects or errors (e.g., improbable or negatively indicated decomposition results) to rerun the decomposition steps above as needed to remove them, and picking a best or otherwise desired candidate(s) from the resultant decompositions. The resultant decompositions and associated data/results/visualizations may then be displayed or outputted, such as in human-readable form such that a human practitioner or other user may use or interpret them, such as for clinical diagnosis, monitoring and/or treatment planning. The decomposition generated by the system may also generally include determination or computation of uncertainty measures at the various steps of the decomposition, such as to calculate values for error at the various steps or for particular calculations in the decomposition.

In some embodiments, the resultant sum of the sub-signals may not approximate the original signal well or at least in certain portions. For example, as the original signal may generally only have positive amplitude above its baseline, it is conceivable that a possible resultant sum of the sub-signals may contain a portion that is of negative amplitude, and during optimization, one may optionally choose to or it may be desirable to, in those portions of negative amplitude, take the maximum of zero and the resultant sum value (i.e. max(0, sum)) to aid in the optimization. In other examples, a sensing mechanism or other physical arrangement of the percussion measurement device may be utilized that may be able to capture the negative amplitude portions that directionally polarized setups (i.e. the piezoelectric sensing element as discussed above) are not able to, such as with a strain gauge-based sensing mechanism or other non-rectifying sensor, or with a design of the percussion measurement device where the energy application tool or other portion that transmits energy/force to the sensing mechanism is able to follow or “stick” to the target object during the percussion to capture movement/force waves/etc. in forward and reverse directions. In such cases, the max(0, sum) operation may generally not be desirable as the resultant signal may not be limited to a positive amplitude.

In some exemplary embodiments, the program logic module may be trained, using machine learning or artificial intelligence methods as discussed above in regard to training, to perform the initial and/or subsequent guesses (i.e. after optimization steps) for the prominent sub-signal in a signal to allow the system to generate a remainder of the signal without the prominent sub-signal, with the sinusoid decomposition of the remainder being performed with other resources of the program logic module or a computing device of the system (e.g. a local computer or a cloud service) to arrive at the decomposition of the full signal into sub-signals. In general and without being bound to any particular theory, many signals may contain a prominent sub-signal that, when determined and removed from the signal, produces a remainder of sub-signals that can be determined without complex machine learning or artificial intelligence methods, such as by utilizing FFT or Fourier-like operations, gradient descent-based methods, etc., such that the intensive resources for the machine learning or artificial intelligence operations may be conserved. For example, removal of the prominent sub-signal (e.g. PDL sub-signal) may result in sub-signals (e.g. sinusoids, etc.) which are more readily discernable, such as by not missing significant portions of the sub-signal(s), “negative” amplitude portions or other features that may require or benefit from machine learning or artificial intelligence methods, which may be employed as necessary.

In some embodiments, the program logic module or another component of the system (e.g. a local computer or a cloud service) may perform the initial and/or subsequent guesses (i.e. after optimization steps) for the prominent sub-signal, such as by performing a fitting of at least a portion of the signal, such as to a basis function (e.g. a Gaussian curve, sinusoid, sinusoid-like curve, etc.).

For example, the program logic module may generally apply algorithms to fit the signal to the basis function, such as by utilizing gradient descent optimization, Levenberg-Marquardt optimization, and/or any other similar or appropriate method or combination/plurality thereof. The system may then generate a remainder of the signal without the prominent sub-signal, with the sinusoid decomposition of the remainder being performed with other resources of the program logic module or a computing device of the system (e.g. a local computer or a cloud service) to arrive at the decomposition of the full signal into sub-signals. In general and without being bound to any particular theory, many signals may contain a prominent sub-signal that, when determined and removed from the signal, produces a remainder of sub-signals that can be determined without complex machine learning or artificial intelligence methods, such as by utilizing FFT or Fourier-like operations, gradient descent-based methods, etc., such that the intensive resources for the machine learning or artificial intelligence operations may be conserved. For example, removal of the prominent sub-signal (e.g. PDL sub-signal) may result in sub-signals (e.g. sinusoids, etc.) which are more readily discernable, such as by not missing significant portions of the sub-signal(s), “negative” amplitude portions or other features that may require or benefit from machine learning or artificial intelligence methods, which may be employed as necessary. The result may generally be an initial guess decomposition, as illustrated in FIG. 4b with the complete signal decomposing into eight component sub-signals and a residual sub-signal (e.g. which may represent noise, miniscule or unimportant portions of the signal). The program logic module may then perform an optimization, as discussed in general above, to minimize differences between the initial guess decomposition and the original signal, such as through optimization algorithms, such as gradient descent or similar algorithms (e.g. as implemented with commercially available or open-source artificial intelligence or high resource computing tools, such as, for example, Google TensorFlow or the like). The optimization algorithm may also be utilized to aid in the guess decomposition where the bottom or negative amplitude of the signal or sub-signal(s) is missing.

As generally discussed above, after the decomposition is optimized, the program logic module (e.g. either automatically or in conjunction with an expert operator) may then identify and address potential errors or defects in the decomposition, and perform subsequent rounds of guess decompositions and optimizations to form an optimized decomposition. Potential errors or defects may, in some examples, represent improbable or impossible physical situations, results that are apparent or likely mathematical errors, overly complex solutions, and/or other results that indicate an improper decomposition or optimization. Corrections made to potential errors or defects in the decomposition may further be incorporated into the program logic module so that it is better able to identify situations where such potential errors or defects may occur due to characteristics of a signal and be thus able to perform more efficient decompositions without generating solutions with such potential errors or defects.

The resulting decompositions of signals obtained, such as clinical signals from measurements in clinical settings, may be compared in various ways to or analyzed in conjunction with a dataset(s) (e.g. large datasets of signals or information/metrics derived from signals from similar objects to the target object in the clinical signal). The dataset(s) may be similar in form or content to the datasets discussed above in regards to training machine learning algorithms, or may be tailored, truncated, augmented or be formed from different sources. In some embodiments, the objects embodied in the signals of the dataset may be real, artificial or simulated, such as with oral tissues, such as teeth, oral restorations, appliances, implants or splints, and/or associated tissues or orthopedic implants. In general, as discussed above, a percussion measurement device may apply mechanical energy to the object (if not simulated on a computer) by percussing and measure energy that is returned to the device after impact with an object or the deceleration of the impactor, such as by measuring force/energy/displacement/etc. that is returned to the percussion measurement device, such as by measuring force, energy, displacement or other physical return value on a sensing mechanism, such as over a period of time, to form a signal. For objects simulated on a computer, an energy return may be simulated, such as through Finite Element Analysis (FEA), such as illustrated with the FEA model shown in FIG. 4d, or a constructed signal or sub-signal(s) may be created on a computer or by manipulating/altering preexisting signal or sub-signal(s). For example and without limitation, a particular dataset may also include or have available data derived from measurements on multiple types of teeth, dental implants/appliances, and/or oral tissues (which may also include simulations of such objects or simulations of the data derived therefrom) for the dental field, and preferably with a large diversity of subjects or conditions such that comparisons or other analysis may be made with many possibilities for the optimized decompositions(s) from the clinical signal. The dataset may also be updated or augmented through continued use of the system in clinical/industrial settings by end users (i.e. clinicians) to provide additional data for comparison or analysis. The improved dataset may be propagated for the various clinicians to utilize via updating (e.g. via updates to the cloud stored/operated portions of the system).

In exemplary aspects of the invention, the signals may be measured from a percussion measurement device percussing objects or simulations of such signals, and may generally be grouped together based on at least one common characteristic within the dataset. Examples of such characteristics may include object type, object size, location in a given space or environment, physical condition (e.g. amount/type/location of damage, physical restoration, etc.), position of measurement with a percussion measurement device, object age, treatments or procedures performed on an object, and/or any other applicable physical conditions or simulations thereof. The groupings, without limitation, may also need not be exclusive and multiple, different, overlapping, ad-hoc and/or complex groupings may be utilized.

In another exemplary aspect of the present invention, the system may generate or calculate various numerical metrics from the decompositions of signals that show statistically significant difference in the datasets such that these numerical metrics may be utilized in probability distributions or heatmaps to aid in predicting or detecting different physical characteristics or attributes by comparison to the numerical metrics derived from decompositions in the clinical setting. For example, numerical metrics generated from datasets that contain known physical characteristics (e.g., damage types on teeth) may be used for comparisons using the same type of numerical metrics derived from a clinical measurement, and the probability or degree of matching may be determined by the system to output the likelihood of a match with that particular physical characteristic.

Types of numerical metrics may include, but are not limited to, normal fit error (NFE), which is the overall error (difference) between an ideal curve (e.g. generated by a defect free object) and the actual test data. These results may be calculated from the signal. In the case of a decomposition of sinusoids or other sub-signals from the original full signal, the NFE may be calculated for the decomposition as the error between the decomposed prominent sinusoid (e.g. the PDL sinusoid) and the full signal (i.e., a sinusoid decomposition NFE or SDNFE). Other numerical metrics may include PDL portion period or frequency, frequencies or periods of other sinusoids, rate of decay of exponentially decaying sinusoids, amplitudes of sinusoids, number of periods in a sinusoid, other statistically significant metrics and/or weighted versions/combinations of any of the above (i.e., to take into account close values or tapered weighting for the distribution of values).

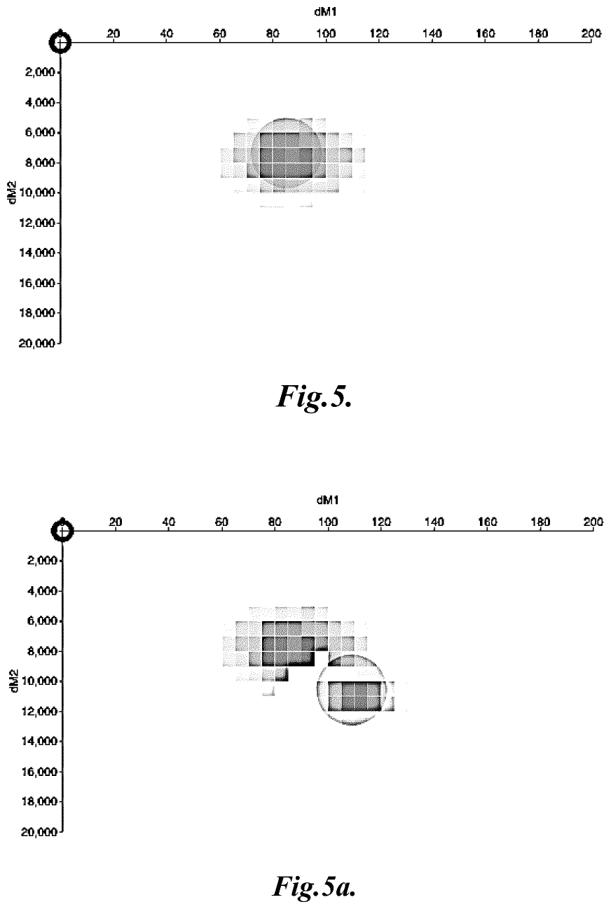

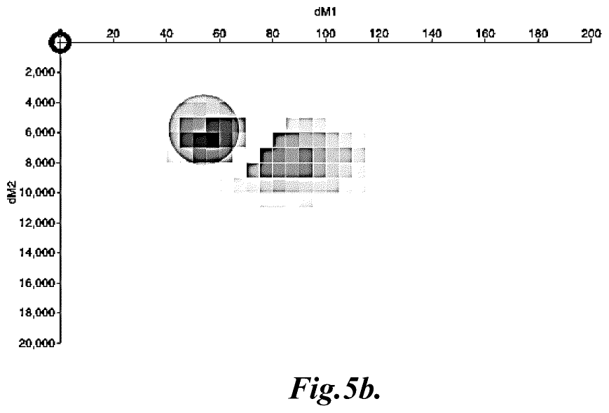

FIGS. 5, 5a and 5b illustrate examples of heatmaps showing distributions of numerical metrics across populations. As illustrated, the darker areas show higher counts and lighter areas show lower counts with the circle showing weight mean sized by standard deviation. Such heatmaps may be desirable or useful in evaluating the probability of a measurement matching to some physical characteristic or combination of characteristics based on cohorts in the dataset of the system that identify with those characteristics or combinations. For example and illustrative purposes, FIG. 5 may illustrate a general population in the dataset, while FIG. 5a may illustrate a cohort (e.g. a group of teeth that were identified to have a particular type of damage) overlaid over the general population, while FIG. 5b may illustrate another cohort (e.g. a group of “good” or healthy/undamaged teeth overlaid over the general population). The placement of a measurement applied to these heatmaps may then, for example, aid in determining if the measured object has a probability of fitting into one population or another.

In general, heatmaps may be of any appropriate dimensionality (e.g. 1-dimensional, 2-dimensional, 3-dimensional, etc.). Some higher dimensionalities may be difficult to visualize or interpret by humans, so computerized interpretations or reductions to numeric or simplified graphical representations may be utilized to aid in a human user's interpretation.

In another aspect of the invention, machine learning algorithms and methods of the system, which may, for example, generally be separated or segregate by use, training or purpose from the machine learning algorithms discussed in regards to signal decomposition or other uses elsewhere, may be trained on a large set of collected percussion data that may be annotated with characteristics (which may be determined by an “expert” or other trusted characterizer or through machine learning algorithms) to identify, guess with a degree of probability and/or associate a measured signal with the particular characteristics or to choose the proper manner of further analysis or algorithmic manipulation to produce useful outputs for a user to utilize or interpret, such as for selecting a proper plan of further diagnosis, monitoring, treatment, etc. For example, signals from a dataset may be correlated with certain physical characteristics as determined by an expert, such as a dental practitioner identifying types or degrees of tooth damage by physical examination, X-ray imaging, deconstruction, etc., which the system may utilize as additional correlation data for signals. Training on these groupings and correlations with the annotations may further be utilized in machine learning assisted analysis of heatmaps of numeric metrics, as discussed above, such as by using the trained machine learning algorithms from such to find correlations and probabilities of matching to populations. This may be desirable in heatmaps or comparisons where dimensionalities or other complexities provide challenges to human interpretation.

The comparisons may also be done using machine learning algorithms to aid in increasing efficiency and improving the probability matching with the known datasets. For example, basic machine learning methods such as, for example, kernel density estimation and/or calibration curve-adjusted Bayesian networks may be utilized. More advanced comparison methods may also be generated utilizing deep learning methods after developing and/or training the machine learning system sufficiently.

In some embodiments, the system may detect numerical metrics in a clinical measurement that may be indicative or suggestive for the user to alter some physical parameters of the clinical measurement, such as changing the parameters of the percussion measurement device, in order to generate better or more accurate data. For example, some numerical metrics may be indicative or suggestive of using a different percussion force, frequency or location on the object for percussion in order to elucidate additional information or to increase the quality of the measurement with a percussion measurement device. The system may, for example, use information not directly derived from an signal in its dataset such as the location of percussion on an object, the percussion force, the percussion measurement device settings during a measurement, and/or other relevant data or factors. The system may then provide feedback for the control of the percussion measurement device, such as to suggest or implement a repeat measurement with different settings, location, timing, etc. Such suggestive/indicative detection by the system may be trained into the program logic module using machine learning methods similar to those discussed above. This may aid in minimizing subjective decisions made by the clinician that may not be possible without the present invention.

The drive mechanism 140 supported inside the housing, such as illustrated in FIG. 2a with housing 132, may generally receive instructions from the system for activating the energy application tool 110 between the resting and active configurations to apply a set amount of energy at a horizontal orientation; with an inclinometer adapted to measure inclination of the energy application tool 110 relative to the horizontal. For a given object, the drive mechanism 140 varies the amount of energy applied to activate the energy application tool 110 between the resting and active configurations based on the inclination to at least approximate the set amount of energy at inclinations other than horizontal. Thus, the same drive mechanism 140 noted above to vary the amount of energy applied (e.g., varying voltage, current or both), may vary the coil drive times (varying the length of time the coil is energized or activated), may vary the coil delay times (varying the time between driving activities), may vary the number of coil energizations (i.e., varying the number of drive pulses applied), polarity of the coil and/or a combination thereof, for the different types of objects mentioned above, and be applicable for modulating the energy application process to mimic a substantially horizontal position during measurement. These factors, including varying power, drive times, polarity and delay times may be managed through varying the firmware settings for power, drive time, number of drives, number of drive pulses, polarity and drive delay of the energizing of the coil for the desired results. Without wishing to be bound to any particular theory, it is surmised multiple variations may be employed to achieve the desired result and the firmware may be designed to select a particular solution or to select an optimal solution for certain instances. Multiple variations may be suggested, adjusted or otherwise indicated to a user by the system based on the program logic module detecting or calculating a probability of a change in the physical parameters of the measurement aiding in increasing accuracy or for elucidating more information about the object. The system may perform some or all of these functions automatically or may alert or indicate the user to adjust the parameters.

In general, when an implant replaces natural tooth due to damage or disease, the ligament is generally lost. However, as noted above, the system and method of the present invention may also be used to evaluate the structural characteristics of an implant structure using abutments. Some materials used for the abutment, for example, composites, gold, and zirconia, may produce sub-signals that somewhat resemble a PDL response.

Further, the present system and method may be useful for measuring the dynamic response when forces are applied to the abutment materials and may also be useful to predict the suitability or compatibility prior to implantation, or to choose suitable materials to protect natural teeth adjacent the implants and to making the better choice of materials to minimize the disparity between the way the implants and natural teeth respond to impact. This may improve the effectiveness of abutment construction and increasing the choices of material or combinations of materials that may be suitable, leading to better patient care.

In some embodiments, the device measurements and/or expert annotations may be stored using a distributed computing environment, such as a cloud. Storage on, for example, a cloud may allow multiple expert annotations to be collected simultaneously and decrease the time for accumulating an expert annotation dataset in order to improve prediction accuracy. In some embodiments, device measurements and/or expert annotations may be collected on multiple instances of the system and consolidated onto one or more of those instances. In some embodiments, the device measurements and/or expert annotations entries may be encrypted.

As mentioned before, machine learning techniques may include regression (e.g., logistic, linear), clustering (e.g., k-means), neural networks (e.g., deep learning), classifiers (e.g., support vector machine, decision tree, random forest), deep learning, etc. The base machine learning techniques utilized may themselves be standardized techniques, and not themselves unique; however, the present inventors have found certain unique adaptations to the types of data stored in a case file to make them useful to a machine learning algorithm. For example, signals produced by a system and method as described herein above and below, for measuring and evaluating structural characteristics of an object, whether anatomical or non-anatomical, in a non-invasive manner and/or using a non-destructive method of measurement may be employed. Structural characteristics of an object may be identified based on measurements of the same or other objects previously made using and captured by the system using a device such as exemplified in FIGS. 2, 2a, 2c, 2d and 2e and their corresponding descriptions, or those as described in U.S. Pat. Nos. 6,120,466, 7,008,385, 6,997,887, 9,358,089 9869606, U.S. Pat. No. 10,488,312, PCT/US17/69164, PCT Patent Application Ser. No. PCT/US 20/40386, U.S. patent publication No. 20190331573, PCT/US2018/068083 and/or PCT publication WO2019133946, which are incorporated by reference in their entireties, may be filtered and transformed into spectrograms for use in deep learning. Models may then be trained, versioned, and stored in a secure database running on a set of centralized cloud-based servers.

### Example of Sinusoid Decomposition Optimization Algorithm

An algorithm may be utilized to optimize the sinusoid decomposition, such as by utilizing a gradient descent optimization, which may, in some exemplary embodiments, utilize an optimization tools package (e.g. Google TensorFlow or the like). An example of a gradient optimization algorithm to utilize with such an optimization tools package is shown below:

### Optimization Algorithm

Find {aᵢ}, {pᵢ}, {oᵢ}, {dᵢ} that minimize the squared error:

$$SquaredError = {\sum }_{t} {[ ResponseForce ( t ) - {\sum }_{i = 0}^{n} Sinusoid ( i , {a}_{i} , {p}_{i} , {o}_{i} , {d}_{i} , t ) ]}^{2}$$

$$where :$$

$$Sinusoid ( i , a , p , o , d , t ) = \{ \begin{matrix}0 & if t \leq o or i = 0 , ( t - o ) > p \\ a \cdot {e}^{- d ( t - o )} \cdot sin \frac{2 π ( t - o )}{p} & otherwise\end{matrix}$$

and:
aᵢ=amplitude for sinusoid i
pᵢ=period for sinusoid i
oᵢ=time offset for sinusoid i
dᵢ=exponential decay rate for sinusoid i

### Other Constraints

There are n+1 sinusoids, and sinusoid i=0 is always assumed to be the PDL sinusoid.
We often set a base decay rate for all sinusoids of dᵢ≥3000 and fix d₀=3000

### Example of Detecting and Addressing Potential Errors/Defects

The table below illustrates examples of potential issues with decompositions performed by the program logic module, such as during training or in decomposing a clinical/industrial measurement signal, the uncertainty such issue generates, how they may potentially be detected, and how they may be addressed by the system.

TABLE 1

| Issue | Area of Uncertainty | How Detected? | How Fixed? |
|---|---|---|---|
| Peaks not captured by | Decomposition may be | There are peaks that | If there are less than 6 |
| decomposition | inaccurate | the fit doesn't cover | sinusoids in the signal, |
| | | | add more sinusoids |
| | | | and reoptimize |
| Decomposition has | Decomposition may be | The fit has more peaks | If there are less than 6 |
| extra peaks | inaccurate | than the signal | sinusoids in the signal, |
| | | | add more sinusoids |
| | | | and reoptimize |
| PDL period too short | PDL period may be | PDL period below | Marked as fatal |
| | longer than actually | hardcoded threshold | uncertainty |
| | reported | per tooth geometry | |
| Crack period longer | Optimizer might have | Crack sinusoid found | Swap crack and PDL |
| than PDL period or | classified PDL | with period longer than | sinusoids; re-optimize |
| similar at high | sinusoid as crack | PDL period or similar | |
| amplitude | sinusoid | with high amplitude | |
| PDL sinusoids starting | PDL period may be | PDL sinusoid starts | Marked as fatal |
| very late in response | longer than actually | well after the start of | uncertainty |
| | reported | the signal | |
| Crack sinusoids | Crack period may be | Crack sinusoid doesn't | Marked as fatal |
| starting very late in | longer than actually | start within the first 1/3 | uncertainty |
| response | reported | of the signal | |
| Mean square error | Decomposition is | MSE between fit and | Marked as fatal |
| (MSE) is too high | likely inaccurate | original signal | uncertainty |

Although the invention has been described with respect to specific aspects, embodiments and examples thereof, these are merely illustrative, and not restrictive of the invention. The description herein of illustrated embodiments of the invention, including the description in the Abstract and Summary, is not intended to be exhaustive or to limit the invention to the precise forms disclosed herein (and in particular, the inclusion of any particular embodiment, feature or function within the Abstract or Summary is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

In general, references to the “cloud” may include both internet connected computing services and/or resources, or those that may exist on smaller or private networks.

In general, “program logic modules” and software elements may generally be configured onto, run, stored, processed and/or executed on separately on different computer processors and/or memories, in combination with each other on the same computer processors and/or memories, and/or on any of the above in varied temporal arrangements, as applicable. Nothing should be implied or construed in this specification as requiring any program logic modules and/or software elements to be run on any one or combination of computing processors and/or memories, and any suitable combination or singular unit may be utilized.

References throughout this specification to “one embodiment”, “an embodiment”, or “a specific embodiment” or similar terminology mean that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein, the meaning of “in” includes “in” and “on” unless the context clearly dictates otherwise.

1. A method for providing a machine learning-trained structural characteristic analysis system comprising:
providing or generating a dataset comprising a plurality of signals from a plurality of groupings of different objects, said signals being generated from a series of percussion measurements on said different objects and being grouped based on a common characteristic of one of said groupings of different objects;
generating a set of optimized signal collections for each of said signals, each of said set of optimized signal collections being generated by:
performing a guess decomposition of each of said signals to generate a signal collection for each signal comprising at least one sub-signal;
performing an optimization operation to minimize differences between said signal collections and each of said signals to generate an optimized signal collection;
identifying and addressing potential errors or defects in each of said optimized signal collection;
repeating said guess decomposition and said optimization operation to regenerate an optimized signal collection after said potential errors or defects are addressed;
selecting at least one desired signal collection from said optimized signal collections for each signal to add to said set of optimized signal collections; and
incorporating said set of optimized signal collections and associated methods for arriving at said set of optimized signal collections into a machine-learning trained analysis system (MLTA); and
connecting said MLTA to a measurement device, said measurement device being adapted to generate a clinical signal data by percussing a target object and transmitting said clinical signal data to said MLTA to enable said MLTA to process said clinical signal data to produce a clinical optimized signal collection and compare characteristics of said clinical optimized signal collection with characteristics of said set of optimized signal collections and present results of comparison in human-readable form.

2. The method of claim 1, wherein said performing an optimization operation comprises minimizing differences between a maximum of a summation and zero of each of said sub-signal collections and each of said signals to generate an optimized signal collection.

3. The method of claim 1, wherein said at least one sub-signal comprises a waveform from a periodontal ligament (PDL) dampening response.

4. The method of claim 1, wherein said guess decomposition is performed using machine learning algorithms for at least one member of said sub-signal collection.

5. The method of claim 1, wherein said signal collection comprises at least one sinusoid sub-signal.

6. The method of claim 1, wherein said signals are generated by a percussion measurement device that only records return signals of positive amplitude relative to a threshold value at a sensing element and said at least one sinusoid waveform is determined by said guess decomposition interpreting said signals as waveforms which may contain missing signal of negative amplitude from said signals.

7. The method of claim 1, wherein said guess decomposition further comprises performing a frequency guess for said at least one sub-signal.

8. The method of claim 1, wherein said common characteristics of said groupings of different objects is selected from the group consisting of tooth type, tooth size, tooth age, degree or type of tooth restoration, degree or type of tooth damage, mandibular location, maxillary location, number of tooth roots, dental or orthodontic treatment, and location of percussion measurement on said object.

9. The method of claim 1, wherein said characteristics of said clinical optimized signal collection and of said set of optimized signal collections are selected from the group consisting of period of a periodontal ligament dampening response (PDLP), frequency of at least one of said sub-signal, rate of decay of exponentially decaying sinusoids, amplitudes of sinusoids, number of periods in a sinusoid, and combinations thereof.

10. The method of claim 1, wherein said different objects are selected from the group consisting of natural teeth, artificial or replica teeth, simulated teeth or oral tissue, restorations of a tooth, oral tissue, dental appliances or implants, and dental splints.

11. The method of claim 1, further comprising performing a guess for said prominent sub-signal using a machine learning algorithm (MLA) on said PLM, said MLA being trained on a dataset comprising a plurality of signals with known prominent sub-signals and known sinusoid decompositions.

12. The method of claim 1, wherein said basis function is selected from the group consisting of a Gaussian curve, an exponential curve, a sinusoid, an exponentially decaying sinusoid, and a sinusoid-like curve.

13. A machine learning-trained structural characteristic analysis system comprising:
a percussion measurement device comprising a control mechanism;
a program logic module connected to said control mechanism, said program logic module provided by:
providing or generating a dataset comprising a plurality of signals from a plurality of objects, said signals being generated from a series of percussion measurements on said objects and being grouped based on a common characteristic;
generating a set of optimized sub-signal collections for each of said signals, each of said set of optimized sub-signal collections being generated by:
performing a guess decomposition of each of said signals to generate a sub-signal collection for each signal comprising at least one sub-signal;
performing an optimization operation to minimize differences between said sub-signal collections and each of said signals to generate an optimized sub-signal collection;
identifying and addressing potential errors or defects in each of said optimized sub-signal collection;
repeating said guess decomposition and said optimization operation to regenerate an optimized sub-signal collection after said potential errors or defects are addressed;
selecting at least one desired sub-signal collection from said optimized sub-signal collections for each signal to add to said set of optimized sub-signal collections; and
incorporating said set of optimized sub-signal collections and associated methods for arriving at said set of optimized sub-signal collections into a machine-learning trained analysis system (MLTA); and
connecting said MLTA to said percussion measurement device, said percussion measurement device being adapted to generate a clinical signal data by percussing a target object and transmitting said clinical signal data to said MLTA to enable said MLTA to process said clinical signal data to produce a clinical optimized sub-signal collection and a comparison of characteristics of said clinical optimized sub-signal collection with characteristics of said set of optimized sub-signal collections and determines physical parameters associated with said comparison; and
a control adjuster connected to said program logic module and said control mechanism, said control adjuster adapted to output changes to said instruction in response to said MLTA outputting a suggested change due to said physical parameters.

14. The system of claim 13, wherein said percussion measurement device further comprises:
a housing having an open front end and a longitudinal axis;
an energy application tool mounted inside said housing, said energy application tool having a resting configuration and an active configuration; and
a drive mechanism supported inside said housing, said drive mechanism being adapted for activating said energy application tool between said resting and active configurations to apply a set amount of energy;
wherein said control mechanism is connected to provide instructions to said drive mechanism, and said drive mechanism varies the amount of energy applied to activate said energy application tool between said resting and active configurations based on input from said control mechanism.

15. The system of claim 13, wherein said percussion measurement device only records return signals of positive amplitude relative to a threshold value at a sensing element.

16. A method for providing a structural characteristic analysis system comprising:
providing a program logic module (PLM) configured to take an input of a signal to generate a signal from a percussion measurement by a percussion measurement device (PMD);
connecting said PLM to said PMD;
performing a percussion measurement on a tooth-like object with said PMD to generate said signal with said PLM;
performing a guess for a prominent sub-signal of said signal by fitting of said signal to a basis function;
subtracting said prominent sub-signal from said signal to form a remainder;
performing a guess sinusoid decomposition on said remainder to generate secondary sub-signals that form in summation with said prominent sub-signal an approximation of said signal;
performing an optimization operation to minimize differences between said approximation of said signal and said signals to generate an optimized sub-signal collection;
identifying and addressing potential errors or defects in each of said optimized sub-signal collection;
repeating said guess for said prominent sub-signal, guess sinusoid decomposition and said optimization operation to regenerate said optimized sub-signal collection after said potential errors or defects are addressed;
selecting at least one desired sub-signal collection from said optimized signal collections; and
presenting said desired sub-signal collection in human-readable form.
